(19) United States
(12) Patent Application Publication
(10) Pub. No.: US 2026/0320847 A1
(43) Pub. Date: Oct. 15, 2026

(54) POINT CLOUD ATTRIBUTE ENCODING AND DECODING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Wenjie ZHU, Shenzhen (CN); Xiaozhong XU, Shenzhen (CN)

(73) Assignee: Tencent Technology (Shenzhen) Company Limited, Shenzhen (CN)

(21) Appl. No.: 19/691,801

(22) Filed: May 29, 2026

Related U.S. Application Data
(63) Continuation of application No. PCT/CN2025/080517, filed on Mar. 4, 2025.

(30) Foreign Application Priority Data
Mar. 4, 2024 (CN) 202410247250.9

(51) Int. Cl. G06T 9/00

(52) U.S. Cl. CPC G06T 9/001

(57) ABSTRACT

A point cloud attribute encoding method and a point cloud attribute decoding method are provided. The decoding method includes determining whether a current point in a current point cloud is a duplicate point, the current point having attribute information to be decoded; based on determining that the current point is the duplicate point, determining, for the current point, an attribute prediction mode including at least one of a pre-order-point-based attribute prediction mode or a K-neighbor-point-based attribute prediction mode; predicting attribute information based on the attribute prediction mode to obtain an attribute predicted value; and determining an attribute reconstructed value based on the attribute predicted value. The encoding method includes corresponding operations for attribute information to be encoded and encodes the attribute information based on the attribute predicted value to obtain a code stream.

### CROSS-REFERENCE TO RELATED APPLICATIONS

International Patent Application No. PCT/CN2025/080517, filed on Mar. 4, 2025, which claims priority to and is based on Chinese Patent Application No. 202410247250.9, filed on Mar. 4, 2024, the disclosures of which are incorporated herein in their entireties by reference.

### FIELD OF THE TECHNOLOGY

Embodiments of the disclosure relate to the field of point cloud encoding/decoding technologies, and in particular, to a point cloud attribute encoding and decoding method and apparatus, a device, a storage medium, and a program product.

### BACKGROUND OF THE DISCLOSURE

A collection device may collect a surface of an object to form point cloud data. The point cloud data may include hundreds of thousands of points or more. Such a large data volume may present challenges in storing and transmitting the point cloud data. Therefore, there is a need to compress the point cloud data before transmission.

Compression of point cloud data may also be referred to as encoding, and may include encoding position information and attribute information. During encoding of the attribute information, redundant information in the point cloud data may be reduced or eliminated by prediction.

Point cloud data may include duplicate points. However, existing attribute encoding methods may not adequately specify how attribute prediction is performed for duplicate points, which may reduce attribute encoding or decoding performance.

### SUMMARY

The disclosure provides a point cloud attribute encoding and decoding method and apparatus, a device, a storage medium, and a program product, to predict and encode attribute information of a duplicate point in point cloud data.

According to an aspect of the disclosure, a point cloud attribute decoding method, performed by a processor device, may be provided. The method may include: determining whether a current point in a current point cloud is a duplicate point, the current point having attribute information to be decoded; based on determining that the current point is the duplicate point, determining, for the current point, an attribute prediction mode, the attribute prediction mode comprising at least one of an attribute prediction mode based on a pre-order point or an attribute prediction mode based on K neighbor points, the pre-order point being an attribute decoded point that precedes the current point in an attribute decoding order for the current point cloud, the K neighbor points being K attribute decoded points nearest to the current point among decoded points in the current point cloud, and K being a positive integer; predicting attribute information based on the attribute prediction mode to obtain an attribute predicted value; and determining an attribute reconstructed value based on the attribute predicted value.

According to an aspect of the disclosure, a point cloud attribute encoding method, performed by a processor device, may be provided. The method may include: determining whether a current point in a current point cloud is a duplicate point, the current point having attribute information to be encoded; based on determining that the current point is the duplicate point, determining, for the current point, an attribute prediction mode, the attribute prediction mode comprising at least one of an attribute prediction mode based on a pre-order point or an attribute prediction mode based on K neighbor points, the pre-order point being an attribute encoded point that precedes the current point in an attribute encoding order corresponding to the current point cloud, the K neighbor points being K attribute encoded points nearest to the current point among encoded points in the current point cloud, and K being a positive integer; predicting attribute information based on the attribute prediction mode to obtain an attribute predicted value of the current point; and encoding the attribute information of the current point based on the attribute predicted value to obtain a code stream.

According to an aspect of the disclosure, a point cloud attribute decoding apparatus may include at least one memory configured to store program code; and at least one processor configured to read the program code and operate as instructed by the program code. The program code may include: duplicate determining code configured to cause the at least one processor to determine whether a current point in a current point cloud is a duplicate point, the current point having attribute information to be decoded; prediction mode determining code configured to cause the at least one processor to, based on determining that the current point is the duplicate point, determine, for the current point, an attribute prediction mode, the attribute prediction mode comprising at least one of an attribute prediction mode based on a pre-order point or an attribute prediction mode based on K neighbor points, the pre-order point being an attribute decoded point that precedes the current point in an attribute decoding order for the current point cloud, the K neighbor points being K attribute decoded points nearest to the current point among decoded points in the current point cloud, and K being a positive integer; prediction code configured to cause the at least one processor to predict attribute information based on the attribute prediction mode to obtain an attribute predicted value; and reconstruction code configured to determine an attribute reconstructed value based on the attribute predicted value.

### BRIEF DESCRIPTION OF DRAWINGS

To describe technical solutions in embodiments of the disclosure more clearly, the following briefly introduces the accompanying drawings required for describing the embodiments. Apparently, the accompanying drawings in the following description show only some embodiments of the disclosure, and a person of ordinary skill in the art may still derive other drawings from these accompanying drawings without creative efforts.

FIG. 1 is a schematic block diagram of a point cloud video encoding/decoding system according to an embodiment of the disclosure.

FIG. 2 is a schematic block diagram of an encoding framework according to an embodiment of the disclosure.

FIG. 3 is a schematic block diagram of a decoding framework according to an embodiment of the disclosure.

FIG. 4 is a schematic diagram of a principle of predicting a transform tree.

FIG. 5 is a flowchart of a point cloud attribute decoding method in an embodiment according to an embodiment of the disclosure.

FIG. 6 is a flowchart of a point cloud attribute encoding method in an embodiment according to an embodiment of the disclosure.

FIG. 7 is a schematic block diagram of an apparatus for predicting a point cloud attribute according to an embodiment of the disclosure.

FIG. 8 is a schematic block diagram of an apparatus for predicting a point cloud attribute according to an embodiment of the disclosure.

FIG. 9 is a schematic block diagram of an electronic device according to an embodiment of the disclosure.

### DETAILED DESCRIPTION

The following describes embodiments of the present disclosure clearly and completely with reference to the accompanying drawings. The described embodiments are merely examples and do not represent all embodiments of the present disclosure. Other embodiments obtained by a person of ordinary skill in the art based on the embodiments of the present disclosure without undue experimentation are within the scope of the present disclosure.

In the present disclosure, claims, and accompanying drawings of the disclosure, the terms “first”, “second”, and the like are used to distinguish between similar elements from each other and are not intended to indicate a particular order or sequence. The terms may be used interchangeably, where appropriate and the embodiments described herein may be implemented in an order different from the order illustrated or described herein. In embodiments of the present disclosure, “B corresponding to A” indicates that B is associated with A. In an implementation, B may be determined based on A. However determining B based on A does not mean that B is determined only based on A, and B may also be determined based on A and/or other information. Moreover, the terms “include”, “contain” and variants thereof are intended to cover the non-exclusive inclusion. For example, a process, method, system, product, device, or server that includes a list of steps or units is not necessarily limited to those steps or units, but may include other steps or units not expressly listed or inherent to such a process, method, product, device, or server. In the present disclosure, unless otherwise specified, “multiple” means two or more than two.

The point cloud attribute encoding and decoding method provided in embodiments of the disclosure may be applied to various fields such as point cloud transmission, video playback, and point cloud encoding/decoding, to accurately predict and encode attribute information of a duplicate point in point cloud data, thereby improving an encoding/decoding effect of point cloud data.

For ease of understanding embodiments of the disclosure, related concepts in embodiments of the disclosure are first briefly described as follows.

A point cloud refers to a group of discrete point sets that are randomly distributed in space and that express a spatial structure and a surface attribute of a three-dimensional object or a three-dimensional scene.

Point cloud data is a specific record form of a point cloud, and a point in the point cloud may include position information of the point and attribute information of the point. For example, the position information of the point may be three-dimensional coordinate information of the point. The position information of the point may also be referred to as geometric information of the point. For example, the attribute information of the point may include color information and/or reflectance. For example, the color information may be information in any color space. For example, the color information may be an RGB. For another example, the color information may be luma and chroma (YcbCr, YUV) information. For example, Y represents luma, Cb (U) represents a blue color difference, Cr (V) represents red, and U and V represent chroma for describing color difference information. For example, for a point cloud obtained according to a laser measurement principle, a point in the point cloud may include three-dimensional coordinate information of the point and laser reflection intensity (reflectance) of the point. For another example, for a point cloud obtained according to a photogrammetric principle, a point in the point cloud may include three-dimensional coordinate information of the point and color information of the point. For another example, for a point cloud obtained by combining laser measurement and photogrammetric principles, a point in the point cloud may include three-dimensional coordinate information of the point, laser reflection intensity of the point, and color information of the point.

An obtaining approach of point cloud data may include, but is not limited to, at least one of the following: (1) generation by a computer device. The computer device may generate point cloud data according to a virtual three-dimensional object and a virtual three-dimensional scene. (2) Acquiring by 3D laser scanning. Point cloud data of a static real world three-dimensional object or three-dimensional scene may be obtained through 3D laser scanning, and million-level point cloud data may be obtained per second. (3) Acquiring by 3D photogrammetric measurement. A visual scene in the real world is collected by using a 3D photography device (that is, a group of cameras or a camera device having a plurality of lenses and sensors) to obtain point cloud data of the visual scene in the real world. Point cloud data of a dynamic real world three-dimensional object or three-dimensional scene may be obtained by using 3D photography. (4) Obtaining point cloud data of a biological tissue organ by using a medical device. In the medical field, point cloud data of a biological tissue organ may be obtained by using a medical device such as magnetic resonance imaging (MRI), computed tomography (CT), or electromagnetic positioning information.

Point clouds may be classified into an intensive point cloud and a sparse point cloud according to obtaining approaches.

Point clouds are classified according to a time sequence type of data into:
a first type of static point cloud, that is, an object is static, and a device obtaining the point cloud is also static;
a second type of dynamic point cloud: an object is moving, but a device obtaining the point cloud is static; and
a third type of dynamic point cloud: a device obtaining the point cloud is moving.

Point clouds are classified into two types according to use of the point clouds:

Category 1: Machine perception point cloud, which can be used in scenarios such as an autonomous navigation system, a real-time inspection system, a geographic information system, a visual sorting robot, and a rescue and disaster relief robot.

Category 2: Human-eye perception point cloud, which can be used in point cloud application scenarios such as digital cultural heritage, free-viewpoint broadcasting, 3D immersive communication, and 3D immersive interaction.

FIG. 1 is a schematic block diagram of a point cloud encoding/decoding system according to an embodiment of the disclosure. FIG. 1 is merely an example, and the point cloud encoding/decoding system according to an embodiment of the disclosure includes but is not limited to FIG. 1. As shown in FIG. 1, the point cloud encoding/decoding system includes an encoding device 110 and a decoding device 120. The encoding device is configured to encode (which may be understood as compressing) point cloud data to generate a code stream, and transmit the code stream to the decoding device. The decoding device decodes the code stream generated by the encoding device through encoding, to obtain decoded point cloud data.

The encoding device 110 in this embodiment of the disclosure may be understood as a device having a point cloud encoding function, and the decoding device 120 may be understood as a device having a point cloud decoding function. That is, the encoding device 110 and the decoding device 120 include a wider range of apparatuses in this embodiment of the disclosure, for example, a smartphone, a desktop computer, a mobile computing apparatus, a notebook computer (for example, a laptop), a tablet computer, a set-top box, a television, a camera, a display apparatus, a digital media player, a point cloud game console, and an in-vehicle computer.

In some embodiments, the encoding device 110 may transmit encoded point cloud data (such as a code stream) to the decoding device 120 through a channel 130. The channel 130 may include one or more media and/or apparatuses capable of transmitting encoded point cloud data from the encoding device 110 to the decoding device 120.

In an example, the channel 130 includes one or more communications media enabling the encoding device 110 to directly transmit the encoded point cloud data to the decoding device 120 in real time. In this example, the encoding device 110 may modulate the encoded point cloud data according to a communications standard and transmit modulated point cloud data to the decoding device 120. The communications medium includes a wireless communications medium such as a radio frequency spectrum. In some embodiments, the communications medium may further include a wired communications medium such as one or more physical transmission lines.

In another embodiment, the channel 130 includes a storage medium, and the storage medium may store the point cloud data encoded by the encoding device 110. The storage medium includes various local access data storage media such as an optical disc, a DVD, and a flash memory. In this example, the decoding device 120 may obtain the encoded point cloud data from the storage medium.

In another embodiment, the channel 130 may include a storage server, and the storage server may store the point cloud data encoded by the encoding device 110. In this example, the decoding device 120 may download the stored encoded point cloud data from the storage server. In some embodiments, the storage server may store the encoded point cloud data and may transmit the encoded point cloud data to the decoding device 120, for example, a web server (for example, configured for a website) or a file transfer protocol (FTP) server.

In some embodiments, the encoding device 110 includes a point cloud encoding device 112 and an output interface 113. The output interface 113 may include a modem and/or a transmitter.

In some embodiments, in addition to the point cloud encoding device 112 and the input interface 113, the encoding device 110 may further include a point cloud source 111. The point cloud source 111 may be understood as a source for obtaining point cloud data.

The point cloud source 111 may include at least one of a point cloud collection apparatus (for example, a scanner), a point cloud file, a point cloud input interface, and a computer graphics system. The point cloud input interface is configured to receive point cloud data from a point cloud content provider, and the computer graphics system is configured to generate point cloud data.

The point cloud encoding device 112 encodes the point cloud data from the point cloud source 111, to generate a code stream. The point cloud encoding device 112 directly transmits encoded point cloud data to the decoding device 120 through the output interface 113. The encoded point cloud data may further be stored in a storage medium or a storage server, for subsequent reading by the decoding device 120.

In some embodiments, the decoding device 120 includes an input interface 121 and a point cloud decoding device 122.

In some embodiments, in addition to the input interface 121 and the point cloud decoding device 122, the decoding device 120 may further include a display apparatus 123.

The input interface 121 includes a receiver and/or a modem. The input interface 121 may receive the encoded point cloud data through the channel 130.

The point cloud decoding device 122 is configured to decode the encoded point cloud data to obtain decoded point cloud data, and transmit the decoded point cloud data to the display apparatus 123.

The display apparatus 123 displays the decoded point cloud data. The display apparatus 123 may be integrated in the decoding device 120 or external to the decoding device 120. The display apparatus 123 may include various display apparatuses, for example, a liquid crystal display (LCD), a plasma display, an organic light emitting diode (OLED) display, or another type of display apparatus.

In addition, FIG. 1 is only an example, and the technical solution of this embodiment of the disclosure is not limited to FIG. 1. For example, the technology of the disclosure may further be applied to single-side point cloud encoding or single-side point cloud decoding.

Since a point cloud is a set of massive points, storing the point cloud not only consumes a large amount of memory but also hinders transmission. Moreover, there is insufficient bandwidth to support transmitting the point cloud directly at a network layer without compression. Therefore, it is necessary to compress the point cloud.

Currently, a point cloud may be compressed by using a point cloud encoding framework.

The point cloud encoding framework may be a geometry point cloud compression (G-PCC) encoding/decoding framework or a video point cloud compression (V-PCC) encoding/decoding framework provided by the Moving Picture Experts Group (MPEG), or may be an AVS-PCC encoding/decoding framework provided by the Audio Video Standard (AVS) organization. The G-PCC and the AVS-PCC are both targeted for a static sparse point cloud, and encoding frameworks thereof are approximately the same. The G-PCC encoding/decoding framework may be configured to compress the first type of static point cloud and the third type of dynamic point cloud, and the V-PCC encoding/decoding framework may be configured to compress the second type of dynamic point cloud. The G-PCC encoding/decoding framework is also referred to as a point cloud encoding/decoding device TMC13, and the V-PCC encoding/decoding framework is also referred to as a point cloud encoding/decoding device TMC2.

An encoding/decoding device applicable to this embodiment of the disclosure is described below by using the G-PCC encoding/decoding framework.

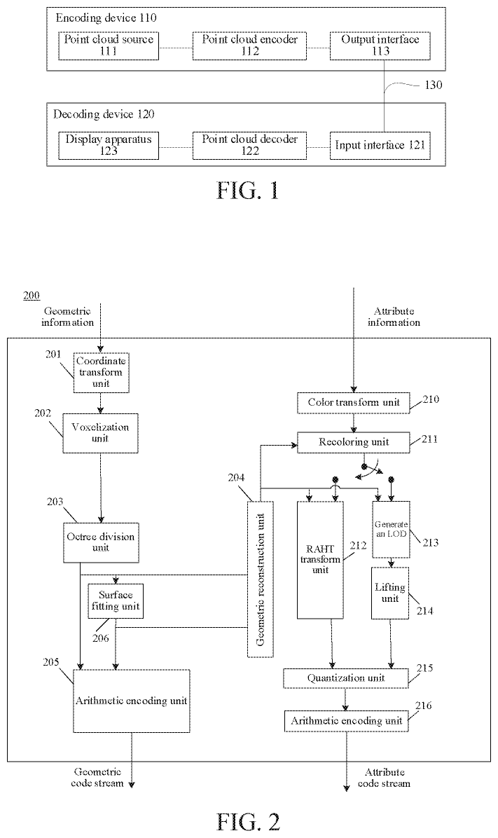

FIG. 2 is a schematic block diagram of a point cloud encoding device according to an embodiment of the disclosure.

As shown in FIG. 2, a point cloud encoding device 200 may obtain position information (also referred to as geometric information or a geometric position) and attribute information of a point cloud from a collection device. Encoding of the point cloud includes position encoding and attribute encoding.

A process of position encoding includes: performing preprocessing on a point in the point cloud, for example, coordinate transform, quantization, and duplicate point removal. Next, geometric encoding is performed on a preprocessed point cloud, for example, constructing an octree, or constructing a prediction tree, and performing geometric encoding based on the constructed octree or prediction tree to form a geometric code stream. Meanwhile, position information of each point in the point cloud data is reconstructed based on position information outputted by the constructed octree or prediction tree, to obtain a reconstructed value of the position information of each point.

A process of attribute encoding includes: performing point cloud prediction by giving reconstruction information of position information and an original value of attribute information of an inputted point cloud and selecting one of three prediction modes, performing quantization on a prediction result, and performing arithmetic encoding to form an attribute code stream.

As shown in FIG. 2, position encoding may be implemented by using the following units:
a coordinate transform unit 201, a voxel unit 202, an octree division unit 203, a geometry reconstruction unit 204, an arithmetic encoding unit 205, and a surface fitting unit 206.

The coordinate transform unit 201 may be configured to transform world coordinates of each point in the point cloud into relative coordinates. For example, subtracting minimum values of x, y, and z coordinate axes from geometric coordinates of a point is equivalent to a direct current removal operation, so as to transform coordinates of the point in the point cloud from world coordinates to relative coordinates.

The voxel unit 202 is also referred to as a quantize and remove points unit, and may reduce a quantity of coordinates through quantization. Different original points after quantization may be endowed with the same coordinates. Based on this, duplicate points may be deleted through a deduplication operation. For example, a plurality of clouds having the same quantization location but different attribute information may be merged into one cloud through attribute transform. In some embodiments of the disclosure, the voxel unit 202 is an exemplary unit module.

The octree division unit 203 may encode location information of a quantized point in an octree encoding manner. For example, the point cloud is divided in a form of an octree. Therefore, a position of a point may be in a one-to-one correspondence with a position of the octree. A position having a point in the octree is counted, and a flag thereof is marked as 1, so as to perform geometric encoding.

In some embodiments, in a process of geometric information encoding based on a triangle soup (trisoup), the point cloud is also octree partitioned by the octree partitioning unit 203. However, unlike octree-based geometric information encoding, this trisoup method does not require partitioning the point cloud down to unit cubes of side length 1×1×1. Instead, the partitioning stops when the block side length reaches W. Based on the surface formed by the distribution of the point cloud within each block, up to twelve vertices (intersection points) generated by the intersection of that surface with the twelve edges of the block are obtained. Surface fitting is then performed on the intersection points by the surface fitting unit 206, and geometric encoding is applied to the fitted intersection points.

The geometry reconstruction unit 204 may reconstruct a position based on the position information outputted by the octree division unit 203 or the intersection point fitted by the surface fitting unit 206, to obtain a reconstructed value of position information of each point in the point cloud data. Alternatively, position reconstruction is performed based on the position information outputted by the prediction tree construction unit 207, to obtain a reconstructed value of position information of each point in the point cloud data.

The arithmetic coding unit 205 may perform, in an entropy encoding manner, arithmetic encoding on the position information outputted by the octree analysis unit 203 or the intersection point fitted by the surface fitting unit 206, to generate a geometric code stream. The geometric code stream may also be referred to as a geometric bitstream.

Attribute encoding may be implemented by using the following units:
a color transform unit 210, a recoloring unit 211, a region adaptive hierarchical transform unit 212, an LOD generation unit 213, a lifting transform unit 214, a quantization coefficient unit 215, and an arithmetic encoding unit 216.

The point cloud encoding device 200 may include more, fewer, or different functional components than those shown in FIG. 2.

The color transform unit 210 may be configured to transform an RGB color space of the point in the point cloud into a YCbCr format or another format.

The recoloring unit 211 recolors color information by using reconstructed geometric information, so that unencoded attribute information corresponds to the reestablished geometric information.

After the original value of the attribute information of the point is obtained through transform by using the recoloring unit 211, any transform unit may be selected to transform the point in the point cloud. The transform unit may include an RAHT transform unit 212 and a lifting transform unit 214. The lifting transform depends on generation of a level of detail (LOD).

Either of the RAHT transform and the lifting transform may be understood as being configured for predicting the attribute information of the point in the point cloud, to obtain a predicted value of the attribute information of the point, and further obtain a residual value of the attribute information of the point based on the predicted value of the attribute information of the point. For example, the residual value of the attribute information of the point may be the original value of the attribute information of the point minus the predicted value of the attribute information of the point.

In an embodiment of the disclosure, a process of generating the LOD by the LOD generation unit includes: obtaining a Euclidean distance between points according to position information of the points in the point cloud; and dividing the points into different detail expression layers according to the Euclidean distance. In an embodiment, Euclidean distances in different ranges may be divided into different detail expression layers after the Euclidean distances are sorted. For example, a point may be randomly selected as a first detail expression layer. Then, a Euclidean distance between the remaining point and the point is calculated, and a point whose Euclidean distance satisfies a first threshold requirement is classified into a second detail expression layer. A centroid of a point in the second detail expression layer is obtained, a Euclidean distance from the point other than those in the first and second detail expression layers to the centroid is calculated, and the point whose Euclidean distance meets a second threshold is classified into a third detail expression layer. The rest can be deduced by analogy, and all points are classified into a detail expression layer. By adjusting the threshold of the Euclidean distance, a quantity of points on each LOD may be increased. The LOD division manner may alternatively be another manner. This is not limited in the disclosure.

The quantization unit 215 may be configured to quantize the residual value of the attribute information of the point. For example, if the quantization unit 215 is connected to the RAHT transform unit 212, the quantization unit 215 may be configured to quantize the residual value of the attribute information of the point outputted by the RAHT transform unit 212.

The arithmetic encoding unit 216 may perform entropy encoding on the residual value of the attribute information of the point by using zero run length coding, to obtain an attribute code stream. The attribute code stream may be bitstream information.

With reference to FIG. 2, in the disclosure, main operations and processing for geometry encoding are as follows:
(1) Pre-processing: including coordinate transform and voxelization. By scaling and translating, point cloud data in three-dimensional space is transformed into an integer form and its minimum geometric position is moved to a coordinate origin.
(2) Geometry encoding: Geometry encoding includes two modes, which may be used in different conditions:
(a) Octree-based geometry encoding (Octree): An octree is a tree-shaped data structure. During 3D space division, a preset bounding box is evenly divided, and each node has eight subnodes. Occupation code information is obtained as a code stream of point cloud geometric information by using “1” and “0” to indicate occupation of each sub-node of the octree.
(b) Geometry encoding based on a triangle representation (Trisoup): The point cloud is divided into blocks of a specific size, intersection points of the point cloud surface on edges of the blocks are located, and a triangle is constructed. Geometric information is compressed by encoding the intersection point location.
(3) Geometric quantization: A degree of precision of quantization is usually determined by a quantization parameter (QP). A larger value of the QP indicates that a coefficient of a larger value range is quantized to the same output, and therefore, a larger distortion and a lower bit rate are generally brought. In contrast, when the value of the QP is relatively small, a coefficient indicating a relatively small value range is quantized to the same output, and therefore, relatively small distortion is usually caused, and the bit rate is relatively high. In point cloud encoding, quantization is directly performed on coordinate information of a point.
(4) Geometry entropy encoding: Statistical compression encoding is performed on occupation code information of the octree, and finally a binary (0 or 1) compressed code stream is outputted. Statistical encoding is a lossless encoding method, which can effectively reduce the bit rate required to express the same signal. A common statistical encoding manner is Content Adaptive Binary Arithmetic Coding (CABAC).

Main operations and processing are as follows for encoding of attribute information:
(1) Recoloring an attribute: In a lossy encoding case, after geometric information is encoded, the encoding device needs to decode and reconstruct the geometric information, that is, recover coordinate information of each point of a 3D point cloud. The original point cloud is searched for attribute information corresponding to one or more neighbor points as attribute information of the reconstruction point.
(2) Attribute predictive encoding: During attribute predictive coding, one or more points are selected as predicted values by using a neighboring relationship of geometric information or attribute information, weighted averaging is performed to obtain final attribute predicted values, and a difference between a true value and a predicted value is coded.
(3) Attribute transform encoding: The attribute transform encoding includes three modes, which may be used in different conditions.
(a) Predictive transform encoding: A sub-point set is selected according to a distance, and a point cloud is divided into a plurality of different levels of detail (LoD), to be represented by coarse to refined point clouds. Bottom-up prediction may be implemented between adjacent levels. That is, attribute information of a point introduced at the refined level is predicted from an adjacent point at the coarse level, to obtain a corresponding residual signal. A point at the lowest level is used as reference information for encoding.
(b) Lifting transform encoding: Based on adjacent LoD prediction, a weight update policy of a neighborhood point is introduced, and a predicted attribute value of each point is finally obtained, to obtain a corresponding residual signal.
(c) Region adaptive hierarchical transform (RAHT) encoding: RAHT transform is performed on attribute information, to transform a signal into a transform domain, which is referred to as a transform coefficient.
(4) Attribute information quantization: Fineness of quantization is usually determined by a quantization parameter (QP). In predictive transform encoding and lifting transform encoding, entropy encoding is performed on a residual value after quantization. In RAHT, entropy encoding is performed on a transform coefficient after quantization.
(5) Attribute entropy encoding: A quantized attribute residual signal or transform coefficient is usually subject to final compression by using run length encoding and arithmetic encoding. Information such as a corresponding encoding mode and a quantizer parameter is also encoded by using an entropy encoding device.

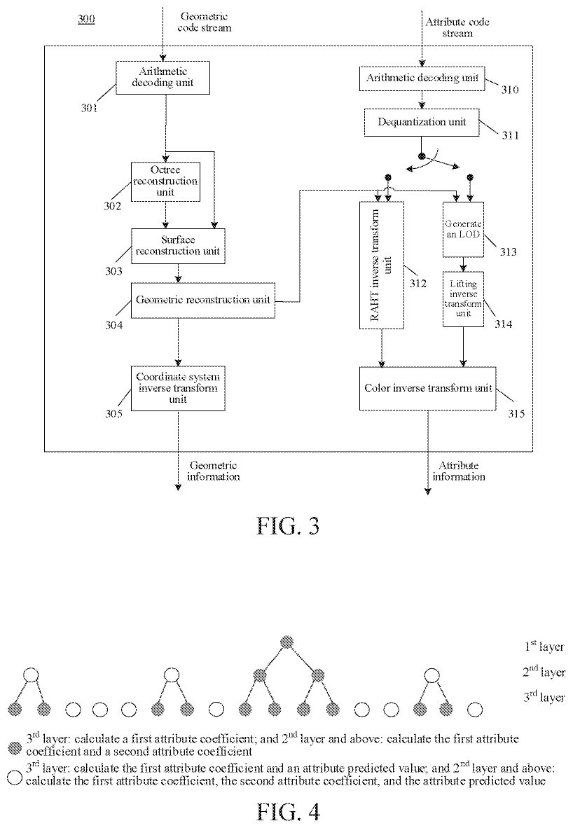

FIG. 3 is a schematic block diagram of a point cloud decoding device according to an embodiment of the disclosure.

As shown in FIG. 3, a point cloud decoding device 300 may obtain a code stream of a point cloud from an encoding device, and obtain position information and attribute information of a point in the point cloud by parsing the code stream. Decoding of the point cloud includes position decoding and attribute decoding.

A position decoding process includes: performing arithmetic decoding on a geometric code stream; and constructing an octree and then performing merging, to reconstruct position information of a point, so as to obtain reconstructed information of the position information of the point; and performing coordinate transform on the reconstruction information of the position information of the point, to obtain the position information of the point. The position information of the point may also be referred to as geometric information of the point.

An attribute decoding process includes: obtaining a residual value of attribute information of a point in the point cloud by parsing an attribute code stream; performing dequantization on the residual value of the attribute information of the point, to obtain a residual value of the attribute information of the point after the dequantization; selecting one of three prediction modes to perform point cloud prediction based on reconstruction information, obtained in a position decoding process, of position information of the point, to obtain a reconstructed value of attribute information of the point; and performing inverse color space transform on the reconstructed value of the attribute information of the point, to obtain a decoded point cloud.

As shown in FIG. 3, position decoding may be implemented by using the following units:
an arithmetic decoding unit 301, an octree reconstruction unit 302, a surface reconstruction unit 303, a geometry reconstruction unit 304, and an inverse transform coordinate unit 305.

Attribute decoding may be implemented by using the following units:
an arithmetic decoding unit 310, an inverse quantization unit 311, an RAHT inverse transform unit 312, an LOD generation unit 313, an inverse lifting unit 314, and an inverse transform color unit 315.

Decompression is a reverse process of compression. Similarly, for functions of units in the decoding device 300, refer to functions of corresponding units in the encoding device 200. In addition, the point cloud decoding device 300 may include more, fewer, or different functional components than those shown in FIG. 3.

Decompression is a reverse process of compression. Similarly, for functions of units in the point cloud decoding device 300, refer to functions of corresponding units in the encoding framework 200.

After the decoding device obtains a compressed code stream, the decoding device first performs entropy decoding, to obtain various mode information and quantized geometric information and attribute information. First, inverse quantization is performed on the geometric information, to obtain reconstructed 3D point position information. In another aspect, inverse quantization is performed on attribute information to obtain residual information, and reconstructed attribute information is obtained according to a used transform mode confirmation reference signal. The reconstructed attribute information is in a one-to-one correspondence with the geometric information in sequence, to generate outputted reconstructed point cloud data.

For example, the point cloud decoding device 300 may divide the point cloud into a plurality of LoDs according to a Euclidean distance between points in the point cloud. Subsequently, attribute information of points in the LoD is successively decoded. For example, a zero count in the zero-run encoding technology is calculated, to decode a residual based on zero_cnt. Next, the decoding framework 300 may perform inverse quantization based on the residual value obtained through decoding, and obtain a reconstructed value of the point cloud by adding a residual value obtained after the inverse quantization and a predicted value of a current point, until all point clouds are decoded. A current point is used as a nearest neighbor of a point in a subsequent LoD, and attribute information of a subsequent point is predicted by using a reconstructed value of the current point.

It can be known from the foregoing FIG. 2 that, the point cloud encoding device 200 mainly includes two parts in function: a position encoding module and an attribute encoding module. The position encoding module is configured to encode position information of a point cloud, to form a geometric code stream. The attribute encoding module is configured to encode attribute information of the point cloud, to form an attribute code stream. The disclosure mainly relates to encoding of the attribute information.

Mode information or parameter information, such as prediction, quantization, encoding, and filtering, determined during encoding of the attribute information of the encoding device is carried in the attribute code stream when necessary. The decoding device parses the attribute code stream and analyzes the attribute bitstream according to existing information to determine mode information or parameter information, such as prediction, quantization, encoding, and filtering, that is the same as the encoding device, thereby ensuring that the reconstructed value of the attribute information obtained by the encoding device is the same as the reconstructed value of the attribute information obtained by the decoding device.

The foregoing describes a basic procedure of a point cloud encoding/decoding device based on a G-PCC encoding/decoding framework. With development of technologies, some modules or operations of the framework or the procedure may be optimized. The disclosure is applicable to the basic procedure of the point cloud encoding/decoding device based on the G-PCC encoding/decoding framework, but is not limited to the framework and the procedure.

The following is an introduction to the related technologies in embodiments of the disclosure.

In some predicted value methods based on duplicate points, let the current point to be decoded be Pⱼ with coordinates (x_{Pj}, y_{Pj}, z_{Pj}), and its previous decoded point to be Pⱼ₋₁ with coordinates (x_{Pj-1}, y_{Pj-1}, z_{Pj-1}). If (x_{Pj}, y_{Pj}, z_{Pj}) is equal to (x_{Pj-1}, y_{Pj-1}, z_{Pj-1}), a duplicate point flag isDuplicatePoint=1 is defined, and the point Pⱼ₋₁ is used as a predicted point for the point Pⱼ to be decoded.

When the current point to be decoded is a duplicate point, for the reflectance attribute, the attribute predicted value of the duplicate point is the attribute reconstructed value of the previous point, and its sign bit does not need to be parsed, that is, it is defaulted to a non-negative number.

For a color attribute, an attribute predicted value of a Y or R component of a duplicate point is an attribute reconstructed value of a previous point, and its sign bit does not need to be parsed, that is, it is defaulted to a non-negative number.

A color residual encoding order switch orderSwitch is a binary variable. A value of ‘0’ indicates that the color residual encoding order is YUV/RGB order; a value of ‘1’ indicates that the color residual encoding order is UYV/GRB order.

The predicted value scheme based on duplicate points is in a closed state in the case of multiple attributes (simultaneously having color and reflectance, etc.).

The attribute prediction process for the point cloud is introduced below.

Attribute encoding of the point cloud mainly includes the following operations:

Operation 1: Reorder the point cloud.

Obtain coordinates (x, y, z) of the point cloud, generate a Morton code or Hilbert code for each point based on a space-filling curve, and sort the codes from smallest to largest to obtain a Morton order or Hilbert order;

Taking the Morton code of geometric coordinates as an example, a geometric position of a point in the point cloud is represented by three-dimensional Cartesian coordinates (X, Y, Z). Each coordinate value is represented by N bits, and coordinates (Xk, Yk, Zk) of a kth point may be represented as:

$$\begin{matrix}{X}^{k} = ( {x}_{N - 1}^{k} {x}_{N - 2}^{k} … {x}_{1}^{k} {x}_{0}^{k} ) \\ {Y}^{k} = ( {y}_{N - 1}^{k} {y}_{N - 2}^{k} … {y}_{1}^{k} {y}_{0}^{k} ) \\ {Z}^{k} = ( {z}_{N - 1}^{k} {z}_{N - 2}^{k} … {z}_{1}^{k} {z}_{0}^{k} )\end{matrix}$$

The Morton code corresponding to the kth point may be expressed as follows:

$${M}^{k} = ( {x}_{N - 1}^{k} {y}_{N - 1}^{k} {z}_{N - 1}^{k} , {x}_{N - 2}^{k} {y}_{N - 2}^{k} {z}_{N - 2}^{k} , … {x}_{1}^{k} {y}_{1}^{k} {z}_{1}^{k} , {x}_{0}^{k} {y}_{0}^{k} {z}_{0}^{k} )$$

Each three bits are represented by an octal number

$${m}_{n}^{k} = ( {x}_{n}^{k} {y}_{n}^{k} {z}_{n}^{k} ) , n = 0 , 1 , … , N - 1 ,$$

and the Morton code corresponding to the kth point may be expressed as:

$${M}^{k} = ( {m}_{N - 1}^{k} {m}_{N - 2}^{k} … {m}_{1}^{k} {m}_{0}^{k} )$$

Operation 2: Select a neighbor point based on the sorted point cloud.

Selection methods for the neighbor point include at least the following:

The first method is distance-based neighbor point selection, and specific operations are as follows:

Among the first maxNumOfNeighbours candidate neighbor points in the Morton order or Hilbert order, calculate the Manhattan distance d=|x−x1|+|y−y1|+|z−z1| from each point (x1, y1, z1) to the current point to be decoded (x, y, z).

In one example, k closest points are determined as neighbors of the current point to be decoded.

In one example, the maximum distance value among the k closest points is determined, all candidate neighbor points with a distance less than or equal to the maximum distance value are taken as neighbors of the current point, and finally, m closest points are determined as the nearest neighbors of the current point to be decoded.

The second method is to select a neighbor point based on a spatial relationship and distance, and specific operations are as follows:

Operation 1: Determine an initial block size, that is, determine initial right shift bits N of a codeword corresponding to each point. On this basis, N+3 is a corresponding parent block range.

Operation 2: Traverse the point cloud in a specific order. For example, the current point P to be decoded performs nearest neighbor search among decoded points (limited to the first K points) within the range of its parent block in block B and its coplanar, collinear, and coincident neighbor blocks.

Operation 3: If not enough neighbor points are found, select the neighbor point based on a distance-based method.

The following is an example of a distance-based neighbor point selection method, which differs in the processing of point cloud data with color, reflectance, or both color and reflectance.

Case 1: For a color attribute, a full search of predicted points is performed based on replacing a farthest point.

First, let a current group to be decoded have L points, and a current point Pi to be decoded be an ith point after geometric decoding point reordering. The 0th point Ps in the group is an sth point after reordering according to the order determined by colorReorderMode (original order, Morton, or Hilbert) (0≤i, s<N, where N is a total number of points to be decoded), and Pi is an nth point in the group (0≤n<L). For a decoding process 1 based on the prediction algorithm, the current group to be decoded has only 1 point, i=s, and Pi and Ps are the same point.

Next, determine a neighbor predicted point.

Let a prediction reference point set be Sp, and an upper limit of the length be maxNumOfNeighbours in aps. Sp contains reconstructed coordinate values and reconstructed color values of up to maxNumOfNeighbours decoded points before a current point index. For the current point Pi to be decoded, the neighbor predicted point is calculated as follows:
If s=0, no search is needed, and {128, 128, 128} is used as the predicted value;
if s=1, P0 is the neighbor predicted point;
if s=2, P0 and P1 are the neighbor predicted points;
if 3<=s<maxNumOfNeighbours, Pi−1, Pi−2, and Pi−3 are the neighbor predicted points; and
if i>=maxNumOfNeighbours, search in Sp for 3 closest points and up to 13 equidistant points to the current point Pi to be decoded (xi, yi, zi) as the neighbor predicted points for the current point to be decoded. For any point Pj (xj, yj, zj) in Sp, a distance d is calculated using the Manhattan distance, defined as: d=|xi−xj|+|yi−yj|+|zi−zj|. If two points have the same distance, a vertex traversed first is preferentially selected.

The search method for the 3 closest points and up to 13 equidistant points as the predicted points for the current point is as follows:
(1) A set of closest points is initialized as an empty set. When the number of points in the neighbor predicted point set is less than 3, that is, when the first 3 points Pi−1, Pi−2, and Pi−3 in Sp for the current point are processed, these 3 points are inserted into the closest point set in descending order of index. After each point is inserted, the points in the closest point set are sorted in ascending order based on the distance between the points in the closest point set and the current point to be decoded, so that the distances of the three sorted points satisfy d1<=d2<=d3. Here, dk represents the distance between the kth point in the closest point set and the current decoded point, where k=1, 2, 3.
(2) Continue searching for a jth point in Sp in descending order of index. When the number of points in the closest point set is equal to 3, if the distance dj between the jth point and the current point to be decoded is equal to d3, an nth point is added to the equidistant point set; if the distance dj between the jth point and the current point to be decoded is less than d3, the point corresponding to d3 is removed from the closest point set and dtemp=d3 is set. The jth point is then added to the closest point set. After the new point is added, the points in the closest point set are again sorted in ascending order based on the distances between the points in the closest point set and the current point to be decoded. Then, the reordered d3 is compared with the distance dtemp of the removed point. If dtemp=d3, the removed point is added to the equidistant point set; otherwise, the equidistant point set is cleared.
(3) Continue until all points in Sp have been searched, finally obtaining 3 closest points and a maximum of 13 equidistant points as predicted points for the current point.

Then, the farthest point is determined.

If s>maxNumOfNeighbours, search for the farthest point from Pi in Sp [n, maxNumOfNeighbours−1]. Assume that the distance of the farthest point from Pi is Dmax. If there are multiple points whose distance from Pi is Dmax, sort them in ascending order of index in Sp, and determine the first one as the farthest point for exchange. Exchange the reconstructed coordinate value and reconstructed color value of the farthest point with the nth point of Sp.

Finally, the prediction reference point set is updated.

After all L points in the current group have been predicted and reconstructed, the prediction reference point set is updated.

If 0<=s<maxNumOfNeighbours, the reconstructed coordinate values and reconstructed color values of the L points in the current group to be decoded are put into Sp. Taking the current point Pi as an example, it is put into the mth point of Sp, where m is equal to 1% maxNumOfNeighbours.

If s>maxNumOfNeighbours, the reconstructed coordinate values and reconstructed color values of the L points in the current group to be decoded are configured for replacing information of the first L points in Sp. Taking the current point Pi as an example, it is configured for replacing the nth point in Sp.

Case 2: For the reflectance attribute, a full search of predicted points based on farthest point replacement and spatial bias is performed.

First, the z-axis coordinate in the three-dimensional Cartesian coordinates of the geometrically decoded point is multiplied by the spatial bias coefficient axisBias in aps, while the x-axis and γ-axis coordinates remain unchanged, and then the geometrically decoded points are reordered.

Let a current group to be decoded have L points, and a current point Pi to be decoded be an ith point after geometric decoding point reordering. The 0th point Ps in the group is an sth point after reordering according to the order determined by reflReorderMode (original order, Morton, or Hilbert) (0≤i, s<N, where N is a total number of points to be decoded), and Pi is an nth point in the group (0≤n<L). For the prediction algorithm, the current group to be decoded has only 1 point, i=s, and Pi and Ps are the same point.

Next, determine a neighbor predicted point.

Let a prediction reference point set be Sp, and an upper limit of the length be maxNumOfNeighbours in aps. Sp contains reconstructed coordinate values and reconstructed reflectance values of up to maxNumOfNeighbours decoded points before a current point index. For the current point Pi to be decoded, the neighbor predicted point is calculated as follows:
If s=0, no neighbor predicted point search is performed, and {0} is used as the predicted value;
if s=1, P0 is the predicted point;
if s=2, P0 and P1 are the predicted points;
if 3<=s<maxNumOfNeighbours, Pi−1, Pi−2, and Pi−3 are the neighbor predicted points; and
if i>maxNumOfNeighbours, search Sp for 3 points closest to the current point Pi to be decoded (xi, yi, zi) as the neighbor predicted points Pj (xj, yj, zj) for the current point to be decoded. For any point Pj (xj, yj, zj) in Sp, the distance d is calculated using the Manhattan distance, defined as: d=|xi−xj|+|yi−yj|+|zi−zj|.

Then, the farthest point is determined.

If s>maxNumOfNeighbours, search for the farthest point from Pi in Sp [n, maxNumOfNeighbours−1. Assume that the distance of the farthest point from Pi is Dmax. If there are multiple points whose distance from Pi is Dmax, sort them in ascending order of index in Sp, and determine the first one as the farthest point for exchange. Exchange the reconstructed coordinate value and reconstructed reflectance value of the farthest point with the nth point of Sp.

Finally, the prediction reference point set is updated.

After all L points in the current group have been predicted and reconstructed, the prediction reference point set is updated:

If 0<=s<maxNumOfNeighbours, the reconstructed coordinate values and reconstructed reflectance values of the L points in the current group to be decoded are put into Sp. Taking the current point Pi as an example, it is put into the mth point of Sp, where m is equal to 1% maxNumOfNeighbours.

If s>maxNumOfNeighbours, the reconstructed coordinate values and reconstructed reflectance values of the L points in the current group to be decoded are configured for replacing information of the first L points in Sp. Taking the current point Pi as an example, it is configured for replacing the nth point in Sp.

Case 3: Predicted point lookup for a multi-attribute point cloud.

First, for a point cloud containing multiple attribute types, a prediction reference point set, denoted as Sp, with a maximum length of maxNumOfNeighbours, is maintained. Sp includes coordinates, a color, and reflectance of a vertex. Let a current group to be decoded have L points, and a current point Pi to be decoded be an ith point after geometric decoding point reordering. The 0th point Ps in the group is an sth point after reordering by Hilbert (0≤i, s<N, where N is a total number of points to be decoded), and Pi is an nth point in the group (0≤n<L). For the prediction algorithm, the current group to be decoded has only 1 point, i=s, and Pi and Ps are the same point.

When crossAttrTypePred=0, the methods of Case 1 and Case 2 are used respectively to predict the color attribute and the reflectance attribute.

When crossAttrTypePred=1, during attribute prediction, for the previously predicted attribute, the corresponding methods of Case 1 and Case 2 are configured for finding predicted points for the color attribute and the reflectance attribute. For the subsequently predicted attribute, the corresponding methods of Case 1 and Case 2 are configured for finding predicted points for the color attribute and the reflectance attribute, where the distance configured for finding the closest point is replaced by the comprehensive distance dis. The corresponding methods of Case 1 and Case 2 are configured for determining the farthest point. After the prediction of the subsequently predicted attribute is completed, the farthest point exchange and update are performed uniformly.

During attribute prediction transform, for the previously predicted attribute, the corresponding methods of Case 1 and Case 2 are configured for finding predicted points for the reflectance attribute and the color attribute. For the subsequently predicted attribute, the corresponding methods of Case 1 and Case 2 are configured for finding predicted points for the color attribute and the reflectance attribute, where the distance configured for finding the closest point is replaced by the comprehensive distance dis.

After the predicted point search for the subsequently predicted attribute is completed, if s>=maxNumOfNeighbours, within Sp [n, maxNumOfNeighbours−1] the point farthest from Pi in terms of geometric information distance disGeom is searched. Assuming the distance of the farthest point from Pi is Dmax, if there are multiple points with a distance of Dmax from Pi, they are sorted in ascending order of their indices in Sp, and the first one is determined as the farthest point for exchange. The coordinates, reflectance reconstruction value, and color reconstruction value of the farthest point are exchanged with the nth point of Sp.

After all L points in the current group have been predicted and reconstructed, the prediction reference point set is updated:

If 0<=s<maxNumOfNeighbours, the coordinates, reflectance reconstruction value, and color reconstruction value of the L points in the current group to be decoded are put into Sp. Taking the current point Pi as an example, it is put into the mth point of Sp, where m is equal to the remainder of i divided by maxNumOfNeighbours.

If s>=maxNumOfNeighbours, the information of the first L points in Sp is replaced with the coordinates, reflectance reconstruction value, and color reconstruction value of the L points in the current group to be decoded. Taking the current point Pi as an example, it is configured for replacing the nth point in Sp.

Operation 3: Based on the attribute reconstructed value of the predicted point, determine an attribute predicted value of the current point to be decoded.

In some embodiments, distance-based weighted calculation is as follows:

The reciprocal of the Manhattan distance between the neighbor point and the current point is used as the weight, and finally, the weighted average of the attribute reconstructed values of the k neighbors is calculated to obtain the attribute predicted value.

The geometric coordinates of the current point are Pj=(xj, yj, zj), and the coordinates of the k predicted points found are: (xⱼₙ, yⱼₙ, zⱼₙ)_{n=1, 2, . . . , k}.

For k color attribute predicted points, define: wⱼₙ=|xⱼ−xⱼₙ|+|yⱼ−yⱼₙ|+|zⱼ−zⱼₙ|, where n=1, 2 . . . , k.

For k reflectance attribute predicted points, define: wⱼₙ=xⱼ−xⱼₙ|+|yⱼ−yⱼₙ|+θzⱼ−zⱼₙ|, where n=1, 2 . . . , k, and the spatial bias coefficient is ?=aps.axisBias θ=aps.axisBias.

The attribute reconstructed values of the k predicted points are: (Âⱼₙ)_{n=1, 2, . . . , k}.

In one example, the weights of the k predicted points are calculated as shown in the following formula (1):

$${\hat{w}}_{jn} = {\prod }_{{l = 1}_{l \neq n}}^{k} {w}_{jl} \qquad ( 1 )$$

In one example, the attribute predicted value of the current point Aⱼ′Aⱼ′ may be calculated by the following formula (2):

$${A}_{J}^{′} = \frac{{\sum }_{n = 1}^{k} {\hat{w}}_{jn} {\hat{A}}_{jn}}{{\sum }_{n = 1}^{k} {\hat{w}}_{jn}} \qquad ( 2 )$$

In some embodiments, weighted calculation based on the distance and other parameters is as follows:

Assume that the geometric coordinates of the current point are Pj=(xj, yj, zj).

Among p predicted points found, there are k neighbor candidate points whose distance is less than the maximum distance value, their coordinates are: (xⱼₙ, yⱼₙ, zⱼₙ)_{n=1, 2, . . . , k}, and attribute reconstructed values are (Âⱼₙ)_{n=1, 2, . . . , k}.

The weights of the k predicted points are:

$${w}_{jn} = \frac{1}{\vert {x}_{j} - {x}_{jn} \vert + \vert {y}_{j} - {y}_{jn} \vert + \vert {z}_{j} - {z}_{jn} \vert} ,$$

where n=1, 2 . . . , k.

Among the p predicted points found, there are r equidistant points whose distance is equal to the maximum distance value, and their coordinates are: (xⱼₘ, yⱼₘ, zⱼₘ)_{m=1, 2, . . . , k}, and attribute reconstructed values are (Âⱼₘ)_{m=1, 2, . . . , r}.

The calculation method for the optimization coefficient dwm is as follows:
When attrQuantParam=0, dwm=1/r; or
when attrQuantParam>0, dwm=1.

The optimized weights of the r equidistant points are:

$${w}_{jm} = \frac{{d}_{wm}}{\vert {x}_{j} - {x}_{jm} \vert + \vert {y}_{j} - {y}_{jm} \vert + \vert {z}_{j} - {z}_{jm} \vert} ,$$

where m=1, 2, . . . , r.

When k=0, the attribute predicted value of the current point is calculated as shown in formula (3):

$${\hat{A}}_{j} = \frac{{\sum }_{m = 1}^{r} {w}_{jm} {\hat{A}}_{jm}}{{\sum }_{m = 1}^{r} {w}_{jm}} \qquad ( 3 )$$

where m=1, 2, . . . , r.

When k>0, the attribute predicted value of the current point is calculated as shown in formula (4):

$${\hat{A}}_{j} = \frac{{\sum }_{n = 1}^{k} {w}_{jn} {\hat{A}}_{jn} + {\sum }_{m = 1}^{r} {w}_{jm} {\hat{A}}_{jm}}{{\sum }_{n = 1}^{k} {w}_{jn} + {\sum }_{m = 1}^{r} {w}_{jm}} \qquad ( 4 )$$

where n=1, 2, . . . , k; m=1, 2, . . . , r.

In some embodiments, the attribute information of the point cloud may also be encoded based on attribute encoding of wavelet transform. Specifically, the following operations are included:

First, construction of a prediction transform tree is performed.

As shown in FIG. 4, the process of constructing a multi-layer prediction transform tree structure based on sorted point cloud data and distances between sorted point cloud data includes:

For a point cloud having N geometric points, an M-layer prediction transform structure is constructed. N points are used as nodes of the lowest layer (Mth layer), and a distance dᵢ between a current point i and a next point i+1 is calculated. If dᵢ² is less than a distance threshold thₘ, a point i and a point i+1 are in a transform mode, and the two points are merged to form their parent node at an (M−1)th layer. These parent nodes constitute nodes of the (M−1)th layer, and are arranged in the order of merging, and geometric coordinates of a parent node are a midpoint position of its two child nodes. If dᵢ² is greater than the distance threshold thₘ, the point i is in a prediction mode, and a next point is continuously processed.

For all nodes at the (M−1)th layer, the above operations are performed to merge them to form nodes at an (M−2)th layer and so on, and nodes at each layer are merged. When the number of nodes at an mth layer is less than 128 or the number of nodes at the mth layer is greater than or equal to half of the number of nodes at an (m+1)th layer, all nodes are merged in pairs without determining a distance relationship. Stop when no nodes are merged at a layer.

The initial value of the distance threshold, that is, the distance threshold th_{M} of the bottommost layer is calculated by dividing the square of the average spatial bounding box side length meanBB of the point cloud by the number numPoints of points in the point cloud, and then dividing by a preset ratio ratio, and finally taking an integer not less than 1. For example, as shown in formula (5):

$${th}_{M} = max ( 1 , \frac{meanBB \times meanBB}{numPoints \times ratio} ) \qquad ( 5 )$$

where the preset ratio ratio is calculated from colorInitPredTransRatio or reflInitPredTransRatio in aps. For example, it may be calculated according to the following formula (6):

ratio=2^{colorInitPredTransRatio}

ratio=2^{reflInitPredTransRatio} (6)

where the update method for the distance threshold thₘ of the mth layer is to multiply the distance threshold of the (m+1)th layer by the number Nₘ₊₁ of nodes at the (m+1)th layer, and then divide by the number Nₘ of nodes at the mth layer, and finally take an integer not less than 1. For example, as shown in formula (7):

$${th}_{m} = max ( 1 , \frac{{th}_{m + 1} \times {N}_{m + 1}}{{N}_{m}} ) \qquad ( 7 )$$

During the process of constructing the prediction transform tree, the distance threshold thₘ of the same layer is also updated. During the construction process of the mth layer, the number of consecutively appearing prediction encoding mode nodes and transform encoding mode nodes is counted, and recorded as Nₚ and Nₜ For the point i, if Nₚ is greater than threshold Tₚ, the distance threshold thₘ=thₘ*2 is updated; if Nₜ is greater than the threshold Tₜ and the distance threshold thₘ is not 1, the distance threshold thₘ=max(1, thₘ/2) is updated. The updated distance threshold thₘ is used to compare subsequent inter-point distances.

After the division, an M-layer prediction transform tree structure is obtained, and hierarchical transform and prediction are performed based on this structure.

Then, inverse transform and prediction of the attribute transform coefficient are performed.

Based on the M-layer prediction transform tree structure and the corresponding decoding method, a point cloud attribute is decoded for each node. Obtain a dequantized attribute transform coefficient (reconstructed DC coefficient of the first layer and reconstructed AC coefficient of another layer) and a dequantized DC residual coefficient (reconstructed DC residual coefficient), and decode them layer by layer from top to bottom.

(1) Layer-based correction is performed on the attribute transform coefficient (reconstructed DC coefficient of the first layer and reconstructed AC coefficient of another layer) and the DC residual coefficient (reconstructed DC residual coefficient).

Multiply reconstructed DC coefficients of nodes at the first layer by (C)^{M-1}, multiply reconstructed AC coefficients of nodes at the mth layer by (C)^{M-m}, and multiply reconstructed DC residual coefficients of nodes at the (m+1)th layer by (C)^{M-m-1}, (m=1, 2, . . . . M−1).

(2) Inverse transform and prediction are performed on a corrected attribute transform coefficient.

Inverse transform of the attribute transform coefficient: For the jth node of the mth layer, the input is attribute transform coefficients of the jth node (reconstructed DC coefficient b₁ and reconstructed AC coefficient b₂), and the inverse transform output corresponding to the reconstructed DC coefficients a₁ and a₂ of the two child nodes is shown in formula (8):

a₁=(b₁+b₂)/2

a₂=(b₁−b₂)/2 (8)

In this way, all nodes at the mth layer are traversed.

(3) Prediction compensation of a direct current residual coefficient is performed.

For the jth node at the (m+1)th layer, if it has no parent node, K (K=3) nearest nodes whose reconstructed DC coefficients have been calculated are searched within the layer, with a search range of 128 points forward and 128 points backward, to calculate the DC predicted value of the jth node. The DC predicted value is added to the reconstructed DC residual coefficient to obtain the reconstructed DC coefficient of the jth node. In this way, all nodes in the (m+1)th layer are traversed.

If there are m nodes whose DC coefficients have been reconstructed, the operations are as follows:
1. When m=0, the color attribute measured values are {128, 128, 128}, and the predicted value of the reflectance attribute is 0;
2. When m≤K, the m nodes are neighbor predicted points;
3. When m>K, for the color attribute, K (K=3) nearest points and up to 13 equidistant points are used as neighbor predicted points for the current point; for the reflectance attribute, K (K=3) nearest points are used as neighbor predicted points for the current point.

Based on m=1, 2, . . . , M−2, M−1, each layer of the M-layer structure is traversed from top to bottom, and the above operations (2) and (3) are cyclically performed to perform relevant calculation. Finally, for the Mth layer of the predicted transform tree, the reconstructed DC coefficient of each node is the attribute decoded value of the node.

In some embodiments, attribute information of a point cloud may be encoded based on attribute encoding that fuses prediction and transform.

First, the point cloud to be encoded, which has undergone color space transform and recoloring, is reordered from smallest to largest according to the Hilbert code, and then adaptive grouping and corresponding K-ary transform are performed. A specific process is as follows:

### (1) Point Cloud Grouping

i) Based on the space-filling curve, the point cloud is grouped sequentially, and points with the same first L bits of the Hilbert code are grouped together.
ii) Fine grouping. When the number of points in the same group is greater than a preset limit, fine grouping is performed.
iii) Grouping may be adjusted according to the number of points in a preceding group.

### (2) Intra-Group Prediction

A predicted point selection range is within the preceding maxNumOfNeighbours points of the first point in the current group.
i) Point-by-point prediction is performed according to an existing prediction method.
ii) A unified predicted value is selected or calculated for each group. For example, a predicted value of the first point in the current group is used as a predicted value of the current group.

### (3) Residual Value Transform

The predicted attribute residual values of each group of points are subjected to K_i-ary DCT transform (K_i=2 . . . 8), and the transformed coefficients are quantized and entropy-encoded. When K_i=1, no transform calculation is performed, and the attribute residual values are directly quantized and entropy-encoded. The obtained transform coefficients are quantized.

The above describes the process related to attribute encoding of the point cloud. There are duplicate points in point cloud data. Current point cloud attribute encoding methods do not explicitly specify the attribute encoding process for duplicate points. For example, when duplicate points exist and ordinary predicted values are configured for calculation, no provisions are made, which leads to low attribute encoding performance for point clouds.

To solve this technical problem, embodiments of the disclosure propose a point cloud attribute encoding and decoding method, which can achieve reliable encoding and decoding of attribute information of duplicate points in a point cloud. Specifically, if a current point is a duplicate point in a current point cloud, an attribute prediction mode of the current point is determined, the attribute prediction mode including at least one of an attribute prediction mode based on a pre-order point and an attribute prediction mode based on K neighbor points, the pre-order point being an attribute decoded point located before the current point in an attribute decoding order of the current point cloud, the K neighbor points being K attribute decoded points nearest to the current point, and K being a positive integer; attribute information of the current point is predicted based on the attribute prediction mode of the current point, to obtain an attribute predicted value of the current point; and an attribute reconstructed value of the current point is determined based on the attribute predicted value of the current point. As can be known, in embodiments of the disclosure, if the current point is a duplicate point, the attribute prediction mode of the current point is determined according to the attribute prediction mode of the pre-order point of the current point and attribute prediction modes of the K neighbor points of the current point, so that the attribute prediction mode of the current point can be accurately predicted, and then the attribute information of the current point is accurately predicted based on the accurately determined attribute prediction mode, so that prediction and encoding/decoding of attribute information of the duplicate point can be implemented, thereby improving attribute encoding/decoding performance of the point cloud.

The point cloud encoding and decoding method in embodiments of the disclosure is described below in conjunction with specific embodiments.

First, taking a decoding end as an example, the point cloud decoding method provided in embodiments of the disclosure is described.

FIG. 5 is a schematic flowchart of a point cloud decoding method according to an embodiment of the disclosure. The point cloud decoding method according to an embodiment of the disclosure may be completed by a processor device, which may be the decoding device shown in FIG. 1 or FIG. 3 above, or a part of the decoding device. For convenience, the following description takes the decoding device as an example of the execution body.

As shown in FIG. 5, the point cloud decoding method according to an embodiment of the disclosure includes:

S101: If a current point whose attribute is to be decoded is a duplicate point in a current point cloud, the decoding device determines an attribute prediction mode of the current point.

The attribute prediction mode includes at least one of an attribute prediction mode based on a pre-order point and an attribute prediction mode based on K neighbor points, the pre-order point is an attribute decoded point located before the current point in an attribute decoding order of the current point cloud, the K neighbor points are K attribute decoded points nearest to the current point, and K is a positive integer.

This embodiment involves a decoding process for the attribute information of the point cloud, and decoding of the attribute information of the point cloud is performed after decoding of position information of the point cloud. The position information of the point cloud is also referred to as geometric information of the point cloud.

In an embodiment of the disclosure, the current point is a point in the current point cloud whose attribute information is to be decoded. In some examples, the current point is also referred to as a current point to be decoded, a point whose current attribute is to be decoded, or the like. A decoded point may be understood as a point whose geometric information has been decoded and a point whose attribute information has been decoded. Specifically, a point cloud code stream includes a geometric code stream and an attribute code stream. The decoding device first decodes the geometric code stream of the point cloud to obtain a reconstructed value of geometric information of a point in the point cloud. Then, the attribute code stream of the point cloud is decoded to obtain the reconstructed value of the attribute information of the point in the point cloud, and the geometric information and the attribute information of the point in the point cloud are combined to obtain a decoded point cloud. The embodiment of the disclosure relates to a decoding process for the point cloud attribute code stream.

In the process of decoding the attribute code stream of the point cloud, the decoding process for each point in the point cloud is the same. Taking a current point to be decoded in the point cloud as an example, it is first determined whether the current point is a duplicate point.

If the current point is not a duplicate point, decoded points in the point cloud are obtained, and at least one neighbor point of the current point is selected from these decoded points. Based on a reconstructed value of attribute information of at least one neighbor point of the current point, a predicted value of the attribute information of the current point is obtained. Then, based on the predicted value of the attribute information of the current point and a residual value of the attribute information of the current point parsed from the attribute code stream of the point cloud, the reconstructed value of the attribute information of the current point is obtained.

If the current point is a duplicate point, an attribute prediction method for the current point is determined, where the attribute prediction method for the current point includes a duplicate point attribute prediction method proposed in the disclosure and another prediction method.

In one example, the decoding device determines a default prediction method at both encoding and decoding ends as the attribute prediction method for the current point.

In some examples, the decoding device decodes the code stream to obtain a flag bit of the attribute prediction method, and then determines the attribute prediction method for the current point based on the flag bit.

In one example, the decoding device determines the attribute prediction method for the current point based on a data type of the current point cloud.

If the decoding device determines that the attribute prediction method for the current point is a duplicate point attribute prediction method proposed in the embodiments of the disclosure based on the above operations, the method of the embodiments of the disclosure is configured for attribute prediction.

The process of determining whether the current point is a duplicate point is described below.

In the embodiment of the disclosure, the decoding device may determine whether the current point is a duplicate point by using at least the following manners:

Manner 1: Obtain a decoded point of the current point cloud, determine a distance between the current point and each decoded point, and then determine whether the current point is a duplicate point based on the distance between the current point and each decoded point.

The decoded point refers to a point whose geometric information and attribute information have both been decoded. The distance between the current point and each decoded point is determined based on the coordinate information of the current point and the coordinate information of the decoded point. Then, whether the current point is a duplicate point is determined based on the distance. For example, if the distance between the current point and one or more decoded points is 0, the current point is determined to be a duplicate point.

In some embodiments, if the current point cloud includes a plurality of types of attribute information, determining the distance between the current point and the decoded point includes the following operations 11 to 14:

Operation 11: Determine a geometric distance between the current point and the decoded point based on the geometric information of the current point and the geometric information of the decoded point.

Operation 12: Determine an attribute distance between the current point and the decoded point based on the attribute information of the current point and the attribute information of the decoded point.

Operation 13: Determine a comprehensive distance between the current point and the decoded point based on the geometric distance and the attribute information.

Operation 14: Determine the distance between the current point and the decoded point based on the comprehensive distance.

In this embodiment, the current point cloud including a plurality of types of attribute information includes the following examples:

Example 1: The current point cloud includes a plurality of types of single-component attribute information. For example, reflectance attribute information is a type of single-component attribute information, and the current point cloud in the embodiment of the disclosure includes a plurality of types of single-component attribute information such as reflectance.

Example 2: The current point cloud includes a plurality of types of multi-component attribute information. For example, color attribute information is a type of multi-component attribute information, for example, including a Y component, a U component, and a V component, or including an R component, a G component, and a B component. The current point cloud in the embodiment of the disclosure includes a plurality of types of multi-component attribute information such as colors.

Example 3: The current point cloud includes at least one type of single-component attribute information and at least one type of multi-component attribute information. For example, the current point cloud includes single-component attribute information such as reflectance and multi-component attribute information such as colors.

In an embodiment of the disclosure, if the current point cloud includes a plurality of types of attribute information, the comprehensive distance between the current point and the decoded point may be determined as the distance between the current point and the decoded point.

A specific calculation process of the comprehensive distance between the current point and the decoded point is described below:

First, the geometric distance disGeom between the current point and a candidate point is calculated.

For example, the Manhattan distance between the current point and the candidate point is determined as the geometric distance between the current point and the decoded point.

Next, the attribute distance disGeom between the current point and the candidate point is calculated. The attribute distance is an absolute value of a residual of decoded attribute information between the current point and the decoded point.

In one example, the distance between the current point and reflectance attribute information of the decoded point is determined according to the following formula (9):

disAttr1=|curRefl−neighRefl| (9)
where curRefl represents reflectance of the current point, and neighRefl represents reflectance of the decoded point.

In one example, the distance between the current point and the color attribute information of the decoded point is determined according to the following formula (10):

disAttr2=|curColor[0]−neighColor[0]|+|curColor[1]−neighColor[1]|+curColor[2]−neighColor[2]| (10)
where curColor represents the color of the current point, neighColor represents the color of the decoded point, and 0, 1, and 3 represent three components of the color, namely, YUV or RGB.

Then, the comprehensive distance dis between the current point and the decoded point is calculated based on the geometric distance disGeom and the attribute distance disAttr between the current point and the decoded point.

In one example, the comprehensive distance dis between the current point and the decoded point is determined according to the following formula (11):

$$dis = disGeom + ( ( round ( λ \cdot round ( \frac{max Geom ≪ 10}{max Attr} ) ) ≫ 20 ) \cdot disAttr ) ≫ 10 \qquad ( 11 )$$

In the above formula (11), maxGeom represents the maximum value of the geometric information, and its calculation formula is shown in formula (12):

max Geom=sps.geomBoundingBoxSize[0]+sps.geomBoundingBoxSize[1]+sps.geomBoundingBoxSize[2] (12)

In the above formula (11), maxAttr represents the maximum value of the encoded attribute information, and its calculation formula is as follows:

For reflectance attribute information:

max Attr=(1<<reflOutputDepth)−1

For color attribute information:

max Attr=3·((1<<colorOutputDepth)−1)
where reflOutputDepth and colorOutputDepth represent the bit depth of reflectance and color, respectively.

In the above formula (11), λ represents the weight of the attribute information distance in the comprehensive distance calculation process.

In one example, the calculation formula of λ is shown in formula (13):

λ=₋crossAttrTypePredParam1·attrQuantParm+crossAttrTypePredParam2 (13)
where attrQuantParm represents a post-prediction attribute quantization parameter, and crossAttrTypePredParam1 crossAttrTypePredParam2 represent parameters in the weight calculation process, respectively.

Exemplarily, when the decoded attribute type is reflectance: crossAttrTypePredParam1=6554, crossAttrTypePredParam2=1258291.

Exemplarily, when the decoded attribute type is color: crossAttrTypePredParam1=1311, crossAttrTypePredParam2=157286.

Based on the above operations, for each decoded point, the decoding device may determine the comprehensive distance between the current point and the decoded point. Then, based on the comprehensive distance, the distance between the current point and the decoded point is determined. For example, the comprehensive distance between the current point and the decoded point is determined as the distance between the current point and the decoded point, or the comprehensive distance between the current point and the decoded point is adjusted as the distance between the current point and the decoded point.

In this way, when whether the current point is a duplicate point is determined based on the comprehensive distance between the current point and the decoded point, accuracy of the determining can be improved.

In addition to using manner 1 to determine whether the current point is a duplicate point, the decoding device may alternatively use manner 2 below to determine whether the current point is a duplicate point.

Manner 2: The decoding device decodes the code stream to obtain a duplicate point flag of the current point, and determines whether the current point is a duplicate point based on the duplicate point flag, where the duplicate point flag is configured for indicating whether the current point is a duplicate point.

In an embodiment of the disclosure, after determining whether the current point is a duplicate point, the encoding device sets the duplicate point flag of the current point and then writes it into the code stream. For example, if the encoding device determines that the current point is a duplicate point, the encoding device sets the duplicate point flag of the current point to a first value (e.g., 1) and then writes it into the code stream. If the encoding device determines that the current point is a duplicate point, the encoding device sets the duplicate point flag of the current point to a second value (e.g., 0) and then writes it into the code stream.

In this way, the decoding device can obtain the duplicate point flag of the current point by decoding the code stream, and then determine whether the current point is a duplicate point based on the duplicate point flag. For example, if the value of the duplicate point flag is the first value (e.g., 1), the current point is a duplicate point; if the value of the duplicate point flag is the second value (e.g., 0), the current point is not a duplicate point.

Manner 3: Determine whether the current point is a duplicate point based on geometric coordinates of the current point and geometric coordinates of a decoded point in the current point cloud.

For example, the geometric coordinates of the current point are compared with the geometric coordinates of each decoded point. If the geometric coordinates of the current point are consistent with the geometric coordinates of one or several decoded points, the current point is determined to be a duplicate point.

Manner 4: Determine whether the current point is a duplicate point based on a sequencing code of the current point and a sequencing code of a decoded point in the current point cloud, the sequencing code being a codeword obtained after geometric coordinates of a point in the point cloud are transformed in point cloud sequencing.

From the above description, it can be learned that when attribute encoding is performed on the point cloud, the coordinates of the point in the point cloud are transformed, for example, into a Morton code, then the point cloud is sorted based on the Morton code of the point in the point cloud, and then the sorted point cloud is subjected to attribute encoding. In an embodiment of the disclosure, the Morton code described above is referred to as a sorting code. Thus, during detection of a duplicate point, the sorting code (for example, Morton code) of the current point may be compared with the sorting code of each decoded point. If the Morton code of the current point is consistent with the Morton code of one or several decoded points, the current point is determined to be a duplicate point.

In the embodiment of the disclosure, when decoding the attribute information of the current point, the decoding device first determines whether the current point is a duplicate point based on the above operations. If the current point is determined to be a duplicate point, the decoding device determines the attribute prediction mode of the current point from an attribute prediction mode based on a pre-order point and an attribute prediction mode based on K neighbor points.

The pre-order point of the current point is an attribute decoded point located before the current point in the attribute decoding order of the current point cloud.

In one example, the pre-order point of the current point is an attribute decoded point located before the current point in the attribute decoding order of the current point cloud.

In one example, the pre-order point of the current point is a plurality of attribute decoded points located before the current point in the attribute decoding order of the current point cloud.

In one example, the pre-order point of the current point may be a duplicate point of the current point, that is, coordinate information of the pre-order point of the current point is the same as or similar to the coordinate information of the current point.

In one example, the pre-order point of the current point may not be a duplicate point of the current point, that is, the coordinate information of the pre-order point of the current point may be different from the coordinate information of the current point.

In the embodiment of the disclosure, if the current point is a duplicate point, the attribute prediction mode of the current point includes at least one of an attribute prediction mode based on a pre-order point and an attribute prediction mode based on K neighbor points.

The attribute prediction mode based on the pre-order point refers to a mode of determining an attribute predicted value of the current point based on an attribute reconstructed value of the pre-order point of the current point. For example, the mode of the attribute prediction mode of the current point is a mode of determining the attribute reconstructed value of the pre-order point as the attribute predicted value of the current point.

The attribute prediction mode based on K neighbor points refers to a mode of determining an attribute predicted value of the current point based on attribute reconstructed values of K neighbor points of the current point. For example, a mode of determining a weighted average of the attribute reconstructed values of the K neighbor points of the current point as the attribute predicted value of the current point, that is, the mode of the attribute predicted value of the current point is the mode of determining the weighted average of the attribute reconstructed values of the K neighbor points of the current point as the attribute predicted value of the current point.

Embodiments of the disclosure do not limit the specific manner in which the decoding device determines the attribute prediction mode of the current point.

In a possible implementation, the encoding device and the decoding device default to one of the attribute prediction mode based on the pre-order point and the attribute prediction mode based on the K neighbor points as the attribute prediction mode of the current point. For example, the encoding device and the decoding device default to the attribute prediction mode based on the pre-order point as the attribute prediction mode of the current point (or the current point cloud).

In a possible implementation, the encoding device selects one attribute prediction mode from the attribute prediction mode based on the pre-order point and the attribute prediction mode based on the K neighbor points as the attribute prediction mode of the current point. For example, the encoding device randomly selects one attribute prediction mode from the attribute prediction mode based on the pre-order point and the attribute prediction mode based on the K neighbor points as the attribute prediction mode of the current point. Alternatively, the encoding device selects an attribute prediction mode with lowest costs from the attribute prediction mode based on the pre-order point and the attribute prediction mode based on the K neighbor points as the attribute prediction mode of the current point. Then, the encoding device writes indication information of the selected attribute prediction mode of the current point into the code stream. In this way, the decoding device obtains the indication information of the attribute prediction mode of the current point by decoding the code stream, and then obtains the attribute prediction mode of the current point based on the indication information. For example, if the attribute prediction mode of the current point is the attribute prediction mode based on the pre-order point, the flag bit in the indication information is set to 0. If the attribute prediction mode of the current point is the attribute prediction mode based on the K neighbor points, the flag bit in the indication information is set to 1. The decoding device may obtain the attribute prediction mode of the current point based on the value of the flag bit in the indication information.

In a possible implementation, the decoding device may further determine the attribute prediction mode of the current point based on the type of the current point cloud. For example, the encoding device and the decoding device agree to use the attribute prediction mode based on the pre-order point for attribute prediction for some types of point clouds, and to use the attribute prediction mode based on the K neighbor points for attribute prediction for some other types of point clouds. In this way, the decoding device may obtain the attribute prediction mode of the current point based on the type of the current point cloud.

In the embodiment of the disclosure, if the current point is a duplicate point, the decoding device determines the attribute prediction mode of the current point based on the foregoing operations. Then, operation S102 is performed.

S102: The decoding device predicts attribute information of the current point based on the attribute prediction mode of the current point, to obtain an attribute predicted value of the current point.

In the embodiment of the disclosure, if the current point is determined to be a duplicate point, the decoding device determines the attribute prediction mode of the current point from an attribute prediction mode based on a pre-order point and an attribute prediction mode based on K neighbor points. Then, the decoding device predicts the attribute information of the current point based on the attribute prediction mode of the current point, to obtain the attribute predicted value of the current point.

The prediction of the attribute information of the current point by the decoding device based on the attribute prediction mode of the current point is described below.

In the embodiment of the disclosure, the prediction of the attribute information of the current point by the decoding device based on the attribute prediction mode of the current point mainly includes the following cases:

Case 1: If the attribute prediction mode of the current point is the attribute prediction mode based on the pre-order point, the foregoing S102 includes the following operations S102-A1 and S102-A2:

S102-A1: The decoding device determines an attribute prediction sub-mode of the current point, the attribute prediction sub-mode including at least one of a single-component attribute prediction mode and a multi-component attribute prediction mode.

S102-A2: The decoding device performs attribute prediction on the current point based on the attribute prediction sub-mode of the current point, to obtain the attribute predicted value of the current point.

In case 1, if the attribute prediction mode of the current point is the attribute prediction mode based on the pre-order point, the attribute prediction mode based on the pre-order point includes a plurality of attribute prediction sub-modes, for example, including a single-component attribute prediction mode and a multi-component attribute prediction mode. The decoding device determines the attribute prediction sub-mode of the current point from the single-component attribute prediction mode and the multi-component attribute prediction mode.

Embodiments of the disclosure do not limit a specific method for determining the attribute prediction sub-mode of the current point.

In a possible implementation, the encoding device and the decoding device default to determining one of the single-component attribute prediction mode and the multi-component attribute prediction mode as the attribute prediction sub-mode of the current point. For example, the single-component attribute prediction mode is defaulted to be determined as the attribute prediction sub-mode of the current point.

In a possible implementation, the decoding device obtains indication information of the attribute prediction sub-mode of the current point by decoding the code stream, and then obtains the attribute prediction sub-mode of the current point based on the indication information. For example, the encoding device selects one attribute prediction mode from the single-component attribute prediction mode and the multi-component attribute prediction mode as the attribute prediction sub-mode of the current point. For example, the encoding device randomly selects one attribute prediction mode from the single-component attribute prediction mode and the multi-component attribute prediction mode as the attribute prediction sub-mode of the current point. Alternatively, the encoding device selects an attribute prediction mode with minimum costs from the single-component attribute prediction mode and the multi-component attribute prediction mode as the attribute prediction sub-mode of the current point. Then, the encoding device writes indication information of the selected attribute prediction sub-mode of the current point into the code stream. In this way, the decoding device can decode the indication information in the code stream to obtain the attribute prediction sub-mode of the current point.

In a possible implementation, the decoding device may further determine the attribute prediction sub-mode of the current point based on the type of attribute information of the current point cloud. In this case, the aforementioned S102-A1 includes the following operations S102-A11 and S102-A12:

S102-A11: The decoding device determines the type of the attribute information of the current point cloud, where the type of attribute information includes at least one of single-component attribute information, multi-component attribute information, and multiple types of attribute information, and the multiple types of attribute information include at least one of the following: N1 types of single-component attribute information, N2 types of multi-component attribute information, N3 types of single-component attribute information, and N4 types of multi-component attribute information, where N1 and N2 are both positive integers greater than 1, and N3 and N4 are positive integers.

S102-A12: The decoding device determines the attribute prediction sub-mode of the current point based on the type of the attribute information of the current point cloud.

In the embodiment of the disclosure, point clouds of different attribute types may use different attribute prediction sub-modes. Based on this, in the embodiment of the disclosure, if the attribute prediction mode of the current point is the attribute prediction mode based on the pre-order point, the decoding device further needs to determine the type of attribute information of the current point cloud, and then determine the attribute prediction sub-mode of the current point based on the type of the attribute information of the current point cloud.

In the embodiment of the disclosure, the type of the attribute information of the point cloud includes at least one of single-component attribute information, multi-component attribute information, and multiple types of attribute information.

The single-component attribute information refers to attribute information that includes only one component, such as a reflectance attribute.

The multi-component attribute information refers to attribute information that includes multiple components, such as a color attribute, including 3 color components, which are Y, U, and V, or R, G, and B.

The multiple types of attribute information refer to at least one of N1 types of single-component attribute information (i.e., including multiple types of single-component attribute information), or N2 types of multi-component attribute information (i.e., including multiple types of multi-component attribute information), or N3 types of single-component attribute information and N4 types of multi-component attribute information (i.e., including at least one type of single-component attribute information and at least one type of multi-component attribute information). For example, the multiple types of attribute information include the following examples:

Example 1: Multiple types of attribute information of the current point cloud include multiple types of single-component attribute information. For example, the current point cloud includes multiple types of single-component attribute information, such as reflectance.

Example 2: Multiple types of attribute information of the current point cloud include multiple types of multi-component attribute information. For example, the current point cloud includes multiple types of multi-component attribute information, such as colors.

Example 3: Multiple types of attribute information of the current point cloud include at least one type of single-component attribute information and at least one type of multi-component attribute information. For example, the current point cloud includes single-component attribute information such as reflectance and multi-component attribute information such as colors.

A specific process for the decoding device to determine the attribute prediction sub-mode of the current point based on the type of the attribute information of the current point cloud in S102-A2 described above is introduced below.

In the embodiment of the disclosure, the decoding device determines the attribute prediction sub-mode of the current point from at least one of the single-component attribute prediction mode and the multi-component attribute prediction mode, based on the type of the attribute information of the current point cloud.

The specific manners of the single-component attribute prediction mode and the multi-component attribute prediction mode are not limited in embodiments of the disclosure.

In some examples, the single-component attribute prediction mode may refer to a mode in which the reconstructed value of the single-component attribute information of the pre-order point of the current point is determined as the predicted value of the single-component attribute information of the current point. For example, the decoding device determines the reconstructed value of the reflectance of the pre-order point as the predicted value of the reflectance of the current point.

In one example, the single-component attribute prediction mode includes at least one of the following modes:

Mode 1: a mode of determining an attribute reconstructed value of first attribute information of the pre-order point as an attribute predicted value of the first attribute information of the current point, and determining a default sign as a residual sign of the first attribute information of the current point or decoding the residual sign of the first attribute information, the first attribute information being any type of single-component attribute information; or That is, in mode 1, the predicted value of the single-component attribute information (e.g., reflectance) of the current point is the attribute reconstructed value of the single-component attribute information of the pre-order point, and the residual sign of the single-component attribute information of the current point may be a default sign, or the residual sign of the single-component attribute information of the current point may be obtained by decoding the code stream.

Mode 2: a mode of determining a default value as an attribute predicted value of first attribute information of the current point, and determining a default sign as a residual sign of the first attribute information of the current point, or decoding the residual sign of the first attribute information. That is, in mode 2, the predicted value of the single-component attribute information of the current point is a default value, and the residual sign of the single-component attribute information of the current point may be a default sign, or the residual sign of the single-component attribute information of the current point may be obtained by decoding the code stream.

In some examples, the multi-component attribute prediction mode may refer to a mode in which attribute reconstructed values of one or more components of M components of the second attribute information of the pre-order point are determined as attribute predicted values of one or more components of the second attribute information of the current point, where the second attribute information is any type of multi-component attribute information including M components, and M is a positive integer greater than 1. For example, if the multi-component attribute information is three components, namely, YUV, an attribute reconstructed value of the Y component of the pre-order point may be determined as the attribute predicted value of the Y component of the current point. Alternatively, the attribute reconstructed value of the Y component of the pre-order point is determined as the attribute predicted value of the Y component of the current point, the attribute reconstructed value of the U component of the pre-order point is determined as the attribute predicted value of the U component of the current point, and the attribute reconstructed value of the V component of the pre-order point is determined as the attribute predicted value of the V component of the current point.

In one example, the multi-component attribute prediction mode includes at least one of the following modes:

Mode 1: a mode of determining attribute reconstructed values of the M components of the second attribute information of the pre-order point as attribute predicted values of the M components of the second attribute information of the current point, and determining a default sign as residual signs of the M components of the second attribute information of the current point, or determining a default sign as residual signs of M1 components in the second attribute information of the current point, and decoding residual signs of M2 components other than the M1 components in the M components of the second attribute information of the current point, or decoding the residual signs of the M components of the second attribute information of the current point, M1 and M2 being both positive integers, and a sum of M1 and M2 being equal to M. That is, in mode 1, the attribute predicted values of the M components of the second attribute information of the current point are the attribute reconstructed values of the M components of the second attribute information of the pre-order point. The residual signs of the M components of the second attribute information of the current point are default signs. Alternatively, the residual signs of the M1 components of the second attribute information of the current point are default signs, and the residual signs of the M2 components are obtained by decoding. Alternatively, the residual signs of the M components of the second attribute information of the current point are all obtained by decoding.

Mode 2: a mode of determining attribute reconstructed values of P components in the M components of the second attribute information of the pre-order point as attribute predicted values of P components of the second attribute information of the current point, determining a default value as attribute predicted values of M-P components of the second attribute information of the current point, and determining a default sign as residual signs of the M components of the second attribute information of the current point, or determining a default sign as residual signs of the P components of the second attribute information of the current point, and decoding residual signs of the M-P components of the second attribute information of the current point, or decoding the residual signs of the M components of the second attribute information of the current point, P being a positive integer less than M. That is, in mode 2, the attribute predicted values of P components in the M components of the second attribute information of the current point are the attribute reconstructed values of P components of the second attribute information of the pre-order point. The residual signs of the M components of the second attribute information of the current point are default signs. Alternatively, the residual signs of the P components of the second attribute information of the current point are default signs, and the residual signs of the M-P components are obtained by decoding. Alternatively, the residual signs of the M components of the second attribute information of the current point are all obtained by decoding.

Mode 3: a mode of determining attribute reconstructed values of R components in the M components of the second attribute information of the pre-order point as attribute predicted values of R components of the second attribute information of the current point, determining, in the attribute prediction mode based on the K neighbor points, attribute predicted values of M-R components of the second attribute information of the current point, determining a default sign as residual signs of the M components of the second attribute information of the current point, or determining a default sign as residual signs of the R components of the second attribute information of the current point, and decoding residual signs of the M-R components of the second attribute information of the current point, or decoding the residual signs of the M components of the second attribute information of the current point, R being a positive integer less than M. That is, in mode 3, the attribute predicted values of the R components in the M components of the second attribute information of the current point are the attribute reconstructed values of the R components of the second attribute information of the pre-order point, and the attribute predicted values of the M-R components of the second attribute information of the current point are determined by the attribute prediction method based on the K neighbor points. The residual signs of the M components of the second attribute information of the current point are default signs. Alternatively, the residual signs of the R components of the second attribute information of the current point are default signs, and the residual signs of the M-R components are obtained by decoding. Alternatively, the residual signs of the M components of the second attribute information of the current point are all obtained by decoding.

The embodiments of the disclosure do not limit the specific manner in which the decoding device determines the attribute prediction sub-mode of the current point based on the type of the attribute information of the current point cloud.

In a possible implementation, if the type of the attribute information of the current point cloud is single-component attribute information, the decoding device determines the single-component attribute prediction mode as the attribute prediction sub-mode of the current point.

For example, the decoding device determines the attribute reconstructed value of the first attribute information of the pre-order point as the attribute predicted value of the first attribute information of the current point, and skips decoding the residual sign bit of the first attribute information of the current point, but determines a default sign as the residual sign of the first attribute information of the current point, where the first attribute information is any type of single-component attribute information.

For another example, the decoding device determines a default value as the attribute predicted value of the first attribute information of the current point, and skips decoding the residual sign bit of the first attribute information of the current point, but determines a default sign as the residual sign of the first attribute information of the current point.

In a possible implementation, if the type of the attribute information of the current point cloud is multi-component attribute information, the decoding device determines the multi-component attribute prediction mode as the attribute prediction sub-mode of the current point.

For example, the decoding device determines the attribute reconstructed values of the M components of the second attribute information of the pre-order point as the attribute predicted values of the M components of the second attribute information of the current point, and determines a default sign as the residual signs of the M components of the second attribute information of the current point, or determines a default sign as the residual signs of the M1 components in the second attribute information of the current point, and decodes the residual signs of the M2 components other than the M1 components in the M components of the second attribute information of the current point, or determines the mode of the residual signs of the M components of the second attribute information of the current point as the attribute prediction sub-mode of the current point.

For another example, the decoding device determines the attribute reconstructed values of the P components in the M components of the second attribute information of the pre-order point as the attribute predicted values of the P components of the second attribute information of the current point, determines a default value as the attribute predicted values of the M-P components of the second attribute information of the current point, and determines a default sign as the residual signs of the M components of the second attribute information of the current point, or determines a default sign as the residual signs of the P components of the second attribute information of the current point, and decodes the residual signs of the M-P components of the second attribute information of the current point, or determines the mode of the residual signs of M components of the second attribute information of the current point as the attribute prediction sub-mode of the current point.

For another example, the decoding device determines the attribute reconstructed values of the R components in the M components of the second attribute information of the pre-order point as the attribute predicted values of the R components of the second attribute information of the current point, determines the attribute predicted values of the M-R components of the second attribute information of the current point by using the attribute prediction method based on the K neighbor points, and determines a default sign as the residual signs of the M components of the second attribute information of the current point, or determines a default sign as the residual signs of the R components of the second attribute information of the current point, and decodes the residual signs of the M-R components of the second attribute information of the current point, or determines the mode of the residual signs of the M components of the second attribute information of the current point as the attribute prediction sub-mode of the current point.

The above examples illustrate several possible attribute prediction sub-modes for the current point when the type of the attribute information of the current point cloud is multi-component attribute information. The attribute prediction sub-mode derived based on the above several possible attribute prediction sub-modes may also be used as a possible attribute prediction sub-mode of the current point.

In a possible implementation, if the type of the attribute information of the current point cloud is multiple types of attribute information, the decoding device determines the attribute prediction sub-mode of the current point from the single-component attribute prediction mode and the multi-component attribute prediction mode based on the multiple types of attribute information included in the current point cloud. For example, the decoding device uses the single-component attribute prediction mode to predict the single-component attribute information of the current point, and uses the multi-component attribute prediction mode to predict the multi-component attribute information of the current point.

In some embodiments, the decoding device determines the attribute prediction sub-mode of the current point from the single-component attribute prediction mode and the multi-component attribute prediction mode based on the multiple types of attribute information included in the current point cloud, at least including the following examples:

Example 1: determining, if the current point cloud includes N1 types of single-component attribute information, the single-component attribute prediction mode as an attribute prediction sub-mode of at least one of the N1 types of single-component attribute information of the current point.

For example, the current point cloud includes a first type of single-component attribute information and a second type of single-component attribute information. In this case, in one example, the single-component attribute prediction mode may be determined as the attribute prediction sub-mode for the first type of single-component attribute information of the current point. For example, the decoding device determines the reconstructed value of the first type of single-component attribute information of the pre-order point of the current point as the predicted value of the first type of single-component attribute information of the current point. In one example, the decoding device may determine the single-component attribute prediction mode as the attribute prediction sub-mode for the first type of single-component attribute information and the second type of single-component attribute information of the current point. For example, the decoding device determines the reconstructed value of the first type of single-component attribute information of the pre-order point of the current point as the predicted value of the first type of single-component attribute information of the current point, and determines the reconstructed value of the second type of single-component attribute information of the pre-order point of the current point as the predicted value of the second type of single-component attribute information of the current point.

Example 2: If the current point cloud includes N2 types of multi-component attribute information, the decoding device determines the multi-component attribute prediction mode as the attribute prediction sub-mode for at least one type of multi-component attribute information in the N2 types of multi-component attribute information of the current point.

For example, the current point cloud includes a first type of multi-component attribute information and a second type of multi-component attribute information. In this case, in one example, the decoding device may determine the multi-component attribute prediction mode as the attribute prediction sub-mode for the first type of multi-component attribute information of the current point. For example, the decoding device determines reconstructed values of one or more components of the first type of multi-component attribute information (for example, the second attribute information) of the pre-order point of the current point as predicted values of one or more components of the first type of multi-attribute information of the current point. In one example, the decoding device may determine the multi-component attribute prediction mode as the attribute prediction sub-mode for the first type of multi-component attribute information and the second type of multi-component attribute information of the current point. For example, the decoding device determines reconstructed values of one or more components of the first type of multi-component attribute information of the pre-order point of the current point as predicted values of one or more components of the first type of multi-component attribute information of the current point, and determines reconstructed values of one or more components of the second type of multi-component attribute information of the pre-order point of the current point as predicted values of one or more components of the second type of multi-component attribute information of the current point.

Example 3: If the current point cloud includes N3 types of single-component attribute information and N4 types of multi-component attribute information, the decoding device determines the single-component attribute prediction mode as the attribute prediction sub-mode for at least one type of single-component attribute information in the N3 types of single-component attribute information, and/or determines the multi-component attribute prediction mode as the attribute prediction sub-mode for at least one type of multi-component attribute information in the N4 types of multi-component attribute information.

For example, assume that the current point cloud includes one type of single-component attribute information A and one type of multi-component attribute information B. In one example, the decoding device determines the single-component attribute prediction mode as the attribute prediction sub-mode for the single-component attribute information A. For example, the reconstructed value of the single-component attribute information A of the pre-order point of the current point is determined as the predicted value of the single-component attribute information A of the current point. In one example, the multi-component attribute prediction mode is determined as the attribute prediction sub-mode for the multi-component attribute information B. For example, reconstructed values of one or more components of the multi-component attribute information B of the pre-order point of the current point are determined as predicted values of one or more components of the multi-component attribute information B of the current point.

After determining the attribute prediction sub-mode of the current point based on the above operations, the decoding device performs operation S102-A2 described above, and performs attribute prediction on the current point based on the attribute prediction sub-mode of the current point to obtain the attribute predicted value of the current point.

For example, if the attribute prediction sub-mode of the current point is the single-component attribute prediction mode, the decoding device determines the attribute reconstructed value of the first attribute information of the pre-order point of the current point as the predicted attribute value of the first attribute information of the current point, where the first attribute information is any type of single-component attribute information. For example, the decoding device determines the reconstructed value of the reflectance of the pre-order point as the predicted value of the reflectance of the current point.

For another example, if the attribute prediction sub-mode of the current point is the single-component attribute prediction mode, the decoding device determines a default value as the predicted attribute value of the first attribute information of the current point. For example, the decoding device determines a default value as the predicted value of the reflectance of the current point.

For another example, if the attribute prediction sub-mode of the current point is the multi-component attribute prediction mode, the decoding device determines attribute reconstructed values of the M components of the second attribute information of the pre-order point as predicted attribute values of the M components of the second attribute information of the current point. Alternatively, the decoding device determines attribute reconstructed values of the P components in the M components of the second attribute information of the pre-order point as predicted attribute values of the P components of the second attribute information of the current point, and determines a default value of the decoding device as predicted attribute values of the M-P components of the second attribute information of the current point. Alternatively, the decoding device determines attribute reconstructed values of the Q components in the M components of the second attribute information of the pre-order point as predicted attribute values of the Q components of the second attribute information of the current point, and the decoding device determines a default value as predicted attribute values of the M-Q components of the second attribute information of the current point. Alternatively, the decoding device determines attribute reconstructed values of the R components in the M components of the second attribute information of the pre-order point as predicted attribute values of the R components of the second attribute information of the current point, and determines predicted attribute values of the M-R components of the second attribute information of the current point by using the first attribute prediction manner.

For another example, if the attribute prediction sub-mode of the first attribute information of the current point is the single-component attribute prediction mode, and the attribute prediction mode of the second attribute information of the current point is the multi-component attribute prediction mode, the decoding device uses the single-component attribute prediction mode to predict the first attribute information of the current point, so as to obtain the predicted value of the first attribute information of the current point. The decoding device uses the multi-component attribute prediction mode to predict the second attribute information of the current point, so as to obtain the predicted value of the second attribute information of the current point.

The foregoing describes a process of predicting the attribute information of the current point when the attribute prediction mode of the current point is the attribute prediction mode based on the pre-order point. The following describes a process of predicting the attribute information of the current point when the attribute prediction mode of the current point is the attribute prediction mode based on the K neighbor points, with reference to case 2.

Case 2: If the attribute prediction mode of the current point is the attribute prediction mode based on the K neighbor points, S102 includes the following operations S102-B1 and S102-B2:

S102-B1: The decoding device selects K neighbor points from the candidate point set of the current point.

S102-B2: The decoding device determines the attribute predicted value of the current point based on an attribute reconstructed value of at least one of the K neighbor points.

In case 2, if the attribute prediction mode of the current point is the attribute prediction mode based on the K neighbor points, the decoding device selects K neighbor points from the candidate point set of the current point, where the selection manner of the K neighbor points may be based on the description of the foregoing embodiments, for example, neighbor point selection based on a distance, or neighbor point selection based on a spatial relationship and a distance. Then, the decoding device determines the attribute predicted value of the current point based on the attribute reconstructed value of at least one of the K neighbor points of the current point.

The embodiments of the disclosure do not limit a specific manner for the decoding device to determine the attribute predicted value of the current point based on the attribute reconstructed value of at least one of the K neighbor points.

In some embodiments, the decoding device directly determines an average value of the attribute reconstructed values of the K1 neighbor points as the attribute predicted value of the current point.

In some embodiments, the decoding device selects, from the K neighbor points, K1 neighbor points whose distances from the current point are less than or equal to a preset value, and determines the attribute predicted value of the current point based on attribute reconstructed values of the K1 neighbor points, K1 being a positive integer less than or equal to K.

The embodiments of the disclosure do not limit a specific value of the preset value, for example, a positive number infinitely close to 0, or 0. The K1 neighbor points may be understood as duplicate points of the current point, so that the decoding device can determine the attribute predicted value of the current point based on the attribute reconstructed values of the K1 neighbor points.

In one example, the decoding device may determine an attribute reconstructed value of any one neighbor point in the K1 neighbor points as the attribute predicted value of the current point.

In one example, the decoding device may determine an average value of the attribute reconstructed values of the K1 neighbor points as the attribute predicted value of the current point.

In one example, the decoding device determines weights of the K1 neighbor points, and then determines the attribute predicted value of the current point based on the weights of the K1 neighbor points and the attribute reconstructed values of the K1 neighbor points.

The embodiments of the disclosure do not limit a specific manner for the decoding device to determine the weights of the K1 neighbor points.

Since the K1 neighbor points are duplicate points of the current point, and distances from the current point are 0, the weights of the K1 neighbor points cannot be determined based on reciprocals of the distances.

In one possible implementation, the decoding device in the embodiment of the disclosure may set the weights of the K1 neighbor points to a preset value (for example, the preset value=1).

In one possible implementation, the decoding device in the embodiment of the disclosure may alternatively set not completely identical weights for the K1 neighbor points. For example, the decoding device may set completely different weights for the K1 neighbor points, or set different weights for some of the K1 neighbor points and the same weight for some of the K1 neighbor points.

In one possible implementation, the decoding device may determine the weights of the K1 neighbor points based on magnitudes of the attribute reconstructed values of the K1 neighbor points. For example, the larger the attribute reconstructed value of the neighbor point, the larger the corresponding weight; the smaller the attribute reconstructed value of the neighbor point, the smaller the corresponding weight.

Based on the foregoing operations, after the decoding device determines the weight of each of the K1 neighbor points, the decoding device determines the attribute predicted value of the current point based on the weights of the K1 neighbor points and the attribute reconstructed values of the K1 neighbor points.

For example, the decoding device determines the weighted average of the attribute reconstructed values of the K1 neighbor points as the attribute predicted value of the current point by performing weighted summation and then averaging the attribute reconstructed values of the K1 neighbor points based on the weight of each of the K1 neighbor points.

In one possible implementation, the decoding device determines weights of the K1 neighbor points and weights of K-K1 neighbor points in the K neighbor points, and determines a weighted average value of the attribute reconstructed values of the K neighbor points as the attribute predicted value of the current point based on the weight of each of the K neighbor points.

The manner for determining the weights of the K1 neighbor points is the same as described above. The weights of the K-K1 neighbor points may be determined in a manner similar to that described in the foregoing embodiments. For example, for a neighbor point 1 in the K-K1 neighbor points, the decoding device determines a reciprocal of a distance between the neighbor point 1 and the current point as a weight of the neighbor point 1. After the weight of each of the K neighbor points is determined, the average of the attribute reconstructed values of the K neighbor points is determined as the attribute predicted value of the current point.

The foregoing embodiments describe the process of determining the attribute predicted value of the current point when the attribute prediction mode of the current point is the attribute prediction mode based on the pre-order point, and describe the process of determining the attribute predicted value of the current point when the attribute prediction mode of the current point is the attribute prediction mode based on the K neighbor points. Then, operation S103 is performed as follows.

S103: The decoding device determines an attribute reconstructed value of the current point based on the attribute predicted value of the current point.

In the embodiment of the disclosure, if the current point is a duplicate point, the decoding device determines the attribute predicted value of the current point based on the foregoing operations, and then determines the attribute residual value of the current point, and determines the attribute reconstructed value of the current point based on the attribute predicted value and the attribute residual value of the current point.

In some embodiments, the encoding device writes the absolute value and the residual sign of the attribute residual value of the current point into the code stream. In this way, the decoding device can obtain the absolute value and the residual sign of the attribute residual value of the current point by decoding the code stream, and then obtain the attribute residual value of the current point based on the absolute value and the residual sign of the attribute residual value of the current point.

In some embodiments, if the attribute prediction mode of the current point is the attribute prediction mode based on the pre-order point, S103 may include the following operations S103-A to S103-D:

S103-A: The decoding device decodes a code stream, and determines an absolute value of an attribute residual value of the current point.

S103-B: The decoding device determines a residual sign of the attribute residual value of the current point based on the attribute prediction sub-mode of the current point.

S103-C: The decoding device obtains the attribute residual value of the current point based on the absolute value and the residual sign of the attribute residual value.

S103-D: The decoding device obtains the attribute reconstructed value of the current point based on the attribute residual value and the attribute predicted value of the current point.

In this embodiment, if the attribute prediction mode of the current point is the attribute prediction mode based on the pre-order point, the decoding device decodes the code stream to obtain the absolute value of the attribute residual value of the current point, and determines the residual sign of the attribute residual value of the current point based on the attribute prediction sub-mode of the current point.

For example, if the attribute prediction sub-mode of the current point includes the single-component attribute prediction mode, the decoding device determines a default sign as the residual sign of the single-component attribute information (for example, the first attribute information) of the current point, and then skips decoding of the residual sign of the single-component attribute information of the current point; or decodes the residual sign of the single-component attribute information of the current point.

For another example, if the attribute prediction sub-mode of the current point includes mode 1 in the multi-component attribute prediction mode, the decoding device determines a default sign as residual signs of the M1 components in the multi-component attribute information (for example, the second attribute information) of the current point, and decodes residual signs of the M2 components in the M components of the second attribute information of the current point other than the M1 components. Alternatively, the decoding device determines a default sign as the residual signs of the M components of the second attribute information of the current point. Alternatively, the decoding device decodes the residual signs of the M components of the second attribute information of the current point.

For another example, if the attribute prediction sub-mode of the current point includes mode 2 in the multi-component attribute prediction mode, the decoding device determines a default sign as residual signs of the P components of the second attribute information of the current point, and decodes residual signs of the M-P components of the second attribute information of the current point. Alternatively, the decoding device determines a default sign as the residual signs of the M components of the second attribute information of the current point. Alternatively, the decoding device decodes the residual signs of the M components of the second attribute information of the current point.

For another example, if the attribute prediction sub-mode of the current point includes mode 3 in the multi-component attribute prediction mode, the decoding device determines a default sign as residual signs of the R components of the second attribute information of the current point, and decodes residual signs of the M-R components of the second attribute information of the current point. Alternatively, the decoding device determines a default sign as the residual signs of the M components of the second attribute information of the current point. Alternatively, the decoding device decodes the residual signs of the M components of the second attribute information of the current point.

That is, in the embodiment of the disclosure, if the current point includes single-component attribute information and/or multi-component attribute information, and at least one component in the single-component attribute information and/or the multi-component attribute information is predicted using the pre-order point, the decoding device may not decode all residual signs of these components (i.e., use default values), or partially decode some and not decode others, or decode all.

In one example, if the current point includes one type of single-component attribute information and/or one type of multi-component attribute information, it is assumed that the single-component attribute information is predicted using the pre-order point, and/or all components in the multi-component attribute information are predicted using the pre-order point. In this case, the decoding device does not decode the residual sign of the single-component attribute and/or the residual signs of the components of the multi-component attribute information, and determines a default sign as the residual sign of the single-component attribute and/or the residual signs of the components of the multi-component attribute information.

In one example, if the current point includes one type of single-component attribute information and/or one type of multi-component attribute information, it is assumed that the single-component attribute information is predicted using the pre-order point, and/or all components in the multi-component attribute information are predicted using the pre-order point. In this case, the decoding device decodes both the residual sign of the single-component attribute and/or the residual signs of the components of the multi-component attribute information.

In one example, if the current point includes one type of single-component attribute information and/or one type of multi-component attribute information, it is assumed that the single-component attribute information is predicted using the pre-order point, and/or all components in the multi-component attribute information are predicted using the pre-order point. In this case, the decoding device does not decode the residual sign of the single-component attribute and/or the residual signs of some components of the multi-component attribute information, and decodes the residual signs of the remaining components.

After determining the residual sign of the current point based on the foregoing operations, the decoding device combines the absolute value of the attribute residual value of the current point with the residual sign to obtain the attribute residual value of the current point. For example, if the absolute value of the attribute residual value of the current point is a, and the attribute residual sign is “−”, it may be determined that the attribute residual value of the current point is −a.

Finally, the decoding device determines the attribute reconstructed value of the current point based on the attribute predicted value and the attribute residual value of the current point. For example, the decoding device adds the attribute predicted value and the attribute residual value of the current point to obtain the attribute reconstructed value of the current point.

The point cloud attribute decoding method provided in the embodiment of the disclosure can achieve fast and effective prediction and decoding of attribute information of a duplicate point in a point cloud. Specifically, if a current point is a duplicate point in a current point cloud, the decoding device determines an attribute prediction mode of the current point, the attribute prediction mode including at least one of an attribute prediction mode based on a pre-order point and an attribute prediction mode based on K neighbor points, the pre-order point being an attribute decoded point located before the current point in an attribute decoding order of the current point cloud, the K neighbor points being K attribute decoded points nearest to the current point, and K being a positive integer; the decoding device predicts attribute information of the current point based on the attribute prediction mode of the current point, to obtain an attribute predicted value of the current point; and determines an attribute reconstructed value of the current point based on the attribute predicted value of the current point. As can be known, in embodiments of the disclosure, if the current point is a duplicate point, the attribute prediction mode of the current point is determined according to the attribute prediction mode of the pre-order point of the current point and attribute prediction modes of the K neighbor points of the current point, so that the attribute prediction mode of the current point can be accurately predicted, and then the attribute information of the current point is accurately predicted based on the accurately determined attribute prediction mode, so that prediction and encoding/decoding of attribute information of the duplicate point can be implemented, thereby improving attribute encoding/decoding performance of the point cloud.

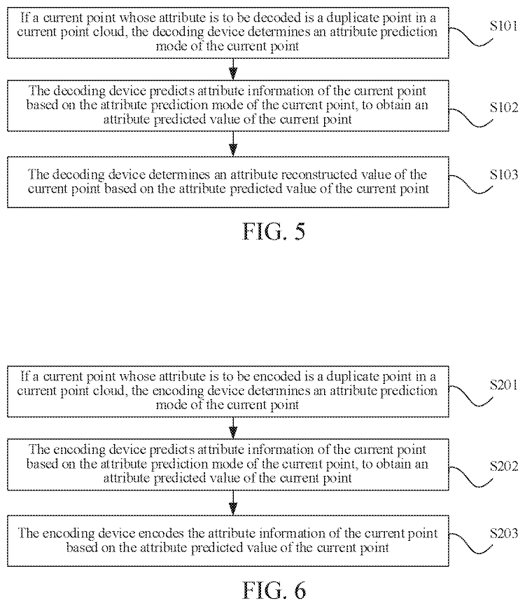

The point cloud attribute decoding method of the decoding device has been described above with reference to FIG. 5. Hereinafter, the technical solution of the disclosure is described with reference to FIG. 6, taking the encoding end as an example.

FIG. 6 is a flowchart of a point cloud attribute encoding method according to an embodiment of the disclosure. The point cloud attribute encoding method according to an embodiment of the disclosure may be completed by a processor device, and the processor device may be the encoding device shown in FIG. 1 or FIG. 2, or a part of the encoding device. For ease of description, the following takes the processor device as an encoding device as an example for description.

As shown in FIG. 6, the point cloud attribute encoding method according to an embodiment of the disclosure includes:

S201: If a current point whose attribute is to be encoded is a duplicate point in a current point cloud, the encoding device determines an attribute prediction mode of the current point.

The attribute prediction mode includes at least one of an attribute prediction mode based on a pre-order point and an attribute prediction mode based on K neighbor points, the pre-order point is an attribute encoded point located before the current point in an attribute encoding order of the current point cloud, the K neighbor points are K attribute encoded points nearest to the current point, and K is a positive integer.

This embodiment involves an encoding process for the attribute information of the point cloud, and encoding of the attribute information of the point cloud is performed after encoding of position information of the point cloud. The position information of the point cloud is also referred to as geometric information of the point cloud.

Before encoding the current point cloud, the encoding device first sorts the current point cloud.

In some embodiments, the encoding device may sort the current point cloud through the following operations 1 and 2:

Operation 1: The encoding device sorts points in the current point cloud based on geometric information of the points in the current point cloud to obtain first sorting.

Operation 2: For duplicate points in the first sorting, the encoding device sorts the duplicate points in the first sorting based on attribute information of the duplicate points to obtain an attribute encoding order of the current point cloud.

In the embodiment of the disclosure, the current point cloud may include duplicate points and non-duplicate points. During sorting, the encoding device first sorts points in the current point cloud based on geometric information of the points in the current point cloud to obtain the first sorting. For example, the encoding device obtains coordinates (x, y, z) of points in the current point cloud, generates a Morton code or Hilbert code for each point based on a space-filling curve, and sorts the Morton codes or Hilbert codes in ascending order to obtain a Morton order or Hilbert order, which is referred to as the first sorting of the current point cloud.

Since duplicate points have the same coordinates, duplicate points in the first sorting cannot be accurately sorted. In this case, for the duplicate points in the first sorting, the encoding device may sort the duplicate points in the first sorting based on attribute information of the duplicate points to obtain the attribute encoding order of the current point cloud.

In the embodiment of the disclosure, the encoding device sorts the duplicate points in the first sorting based on the attribute information of the duplicate points to obtain the attribute encoding order of the current point cloud, which specifically includes the following manners:

Manner 1: If the attribute information of the duplicate points includes single-component attribute information, the encoding device sorts the duplicate points in the first sorting according to the size of the single-component attribute information to obtain the attribute encoding order of the current point cloud.

For example, the current point cloud includes a duplicate point 1, a duplicate point 2, and a duplicate point 3, where the duplicate point 1, the duplicate point 2, and the duplicate point 3 include single-component attribute information, such as reflectance attributes. After the encoding device sorts the points in the current point cloud based on the geometric information to obtain the first sorting, for the duplicate point 1, the duplicate point 2, and the duplicate point 3 in the first sorting, the three duplicate points are sorted in ascending or descending order according to reflectance of the three duplicate points to obtain the attribute encoding order of the current point cloud.

Manner 2: If the attribute information of the duplicate points includes multi-component attribute information, the encoding device sorts the duplicate points in the first sorting according to the size of the attribute information under one component in the multi-component attribute information to obtain the attribute encoding order of the current point cloud.

For example, the current point cloud includes the duplicate point 1, the duplicate point 2, and the duplicate point 3, where the three duplicate points include multi-component attribute information, such as color attributes. After the encoding device sorts the points in the current point cloud based on the geometric information to obtain the first sorting, for the duplicate point 1, the duplicate point 2, and the duplicate point 3 in the first sorting, the three duplicate points are sorted in ascending or descending order according to the size of the Y component (which can also be the U component or V component) in the color attributes of the three duplicate points to obtain the attribute encoding order of the current point cloud.

Manner 3: If the attribute information of the duplicate points includes multi-component attribute information, the encoding device sorts the duplicate points in the first sorting according to the size of the attribute information under each component in the multi-component attribute information to obtain the attribute encoding order of the current point cloud.

For example, the current point cloud includes the duplicate point 1, the duplicate point 2, and the duplicate point 3, where the three duplicate points include multi-component attribute information, such as color attributes. After the encoding device sorts the points in the current point cloud based on the geometric information to obtain the first sorting, for the duplicate point 1, the duplicate point 2, and the duplicate point 3 in the first sorting, the three duplicate points are sorted in ascending or descending order according to the size of the Y component in the color attributes of the three duplicate points to obtain the attribute encoding order of the current point cloud under the Y component. The three duplicate points are sorted in ascending or descending order according to the size of the U component in the color attributes of the three duplicate points to obtain the attribute encoding order of the current point cloud under the U component. The three duplicate points are sorted in ascending or descending order according to the size of the V component in the color attributes of the three duplicate points to obtain the attribute encoding order of the current point cloud under the V component. That is, in manner 3, for the color attributes, the encoding device may obtain the attribute encoding order under each of the three components, Y, U, and V.

Manner 4: If the duplicate point attribute information includes N1 types of single-component attribute information, the encoding device sorts the duplicate points in the first sorting according to the size of one type of single-component attribute information in the N1 types of single-component attribute information to obtain the attribute encoding order of the current point cloud. Alternatively, the encoding device sorts the duplicate points in the first sorting separately according to the size of the attribute information under each single component in the N1 types of single-component attribute information to obtain the attribute encoding order corresponding to the N1 types of single-component attribute information of the current point cloud, where N1 is a positive integer greater than 1.

For example, if the duplicate points include single-component attribute information 1 and single-component attribute information 2, the encoding device sorts the duplicate points in the first sorting according to the single-component attribute information 1 (or the single-component attribute information 2) of the duplicate points to obtain the attribute encoding order of the current point cloud. Alternatively, the encoding device sorts the duplicate points in the first sorting according to the single-component attribute information 1 of the duplicate points to obtain the attribute encoding order corresponding to the single-component attribute information 1, and the encoding device sorts the duplicate points in the first sorting according to the single-component attribute information 2 of the duplicate points to obtain the attribute encoding order corresponding to the single-component attribute information 2.

Manner 5: If the attribute information of the duplicate points includes N2 types of multi-component attribute information, the encoding device sorts the duplicate points in the first sorting according to the size of the attribute information under one component of an ith type of multi-component attribute information in the N2 types of multi-component attribute information to obtain the attribute encoding order of the current point cloud; or the encoding device sorts the duplicate points in the first sorting separately according to the size of the attribute information under one component of each multi-component in the N2 types of multi-component attribute information to obtain the attribute encoding order corresponding to the N2 types of attribute information of the current point cloud, where N2 is a positive integer greater than 1, and i is a positive integer less than or equal to N2; or the encoding device sorts the duplicate points in the first sorting separately according to the size of the attribute information under each component of each multi-component in the N2 types of multi-component attribute information to obtain the attribute encoding order corresponding to each component in the N2 types of attribute information of the current point cloud, where N2 is a positive integer greater than 1, and i is a positive integer less than or equal to N2.

For example, the duplicate points include multi-component attribute information 1 and multi-component attribute information 2, where multi-component attribute information 1 includes 2 components, and multi-component attribute information 2 includes 3 components. In this case, the sorting manners include at least the following:

Type 1: The encoding device sorts the duplicate points in the first sorting according to the size of one component in the multi-component attribute information 1 (or the multi-component attribute information 2) to obtain the attribute encoding order of the current point cloud.

Type 2: The encoding device sorts the duplicate points in the first sorting according to the size of one component in the multi-component attribute information 1 to obtain the attribute encoding order corresponding to the multi-component attribute information 1 of the current point cloud. The encoding device sorts the duplicate points in the first sorting according to the size of one component in the multi-component attribute information 2 to obtain the attribute encoding order corresponding to the multi-component attribute information 2 of the current point cloud.

Type 3: The encoding device sorts the duplicate points in the first sorting according to the size of the first component in the multi-component attribute information 1 to obtain the attribute encoding order corresponding to the first component in the multi-component attribute information 1 of the current point cloud. The encoding device sorts the duplicate points in the first sorting according to the size of the second component in the multi-component attribute information 1 to obtain the attribute encoding order corresponding to the second component in the multi-component attribute information 1 of the current point cloud. The encoding device sorts the duplicate points in the first sorting according to the size of the first component in the multi-component attribute information 2 to obtain the attribute encoding order corresponding to the first component in the multi-component attribute information 2 of the current point cloud. The encoding device sorts the duplicate points in the first sorting according to the size of the second component in the multi-component attribute information 2 to obtain the attribute encoding order corresponding to the second component in the multi-component attribute information 2 of the current point cloud. The encoding device sorts the duplicate points in the first sorting according to the size of the third component in the multi-component attribute information 2 to obtain the attribute encoding order corresponding to the third component in the multi-component attribute information 2 of the current point cloud.

Manner 6: If the attribute information of the duplicate points includes N3 types of single-component attribute information and N4 types of multi-component attribute information, the encoding device sorts the duplicate points in the first sorting according to the size of one or each type of single-component attribute information in the N3 types of single-component attribute information, and/or according to the size of the attribute information under one component or each component of one or each type of multi-component attribute information in the N4 types of multi-component attribute information, to obtain the attribute encoding order of each attribute of the current point cloud, where N3 and N4 are positive integers.

Manner 6 may be obtained based on any one or a combination of the above manners 1 to 5.

For example, assume that the duplicate points include one type of single-component attribute information 1 and one type of multi-component attribute information 2, where the multi-component attribute information 2 includes 3 components. In this case, the sorting manners include at least the following:

Manner 1: The encoding device sorts the duplicate points in the first sorting according to the size of the single-component attribute information 1 to obtain the attribute encoding order of the current point cloud.

Manner 2: The encoding device sorts the duplicate points in the first sorting according to the size of one component in the multi-component attribute information 1 to obtain the attribute encoding order of the current point cloud.

Manner 3: The encoding device sorts the duplicate points in the first sorting according to the size of the first component in the multi-component attribute information 1 to obtain the attribute encoding order corresponding to the first component in the multi-component attribute information 1 of the current point cloud. The encoding device sorts the duplicate points in the first sorting according to the size of the second component in the multi-component attribute information 1 to obtain the attribute encoding order corresponding to the second component in the multi-component attribute information 1 of the current point cloud. The encoding device sorts the duplicate points in the first sorting according to the size of the third component in the multi-component attribute information 1 to obtain the attribute encoding order corresponding to the third component in the multi-component attribute information 1 of the current point cloud.

Manner 4: The encoding device sorts the duplicate points in the first sorting according to the size of the single-component attribute information 1 to obtain the attribute encoding order corresponding to the single-component attribute information 1 of the current point cloud. The encoding device sorts the duplicate points in the first sorting according to the size of one component in the multi-component attribute information 1 to obtain the attribute encoding order corresponding to the multi-component attribute information 1 of the current point cloud.

Manner 5: The encoding device sorts the duplicate points in the first sorting according to the size of the single-component attribute information 1 to obtain the attribute encoding order corresponding to the single-component attribute information 1 of the current point cloud. The encoding device sorts the duplicate points in the first sorting according to the size of the first component in the multi-component attribute information 1 to obtain the attribute encoding order corresponding to the first component in the multi-component attribute information 1 of the current point cloud. The encoding device sorts the duplicate points in the first sorting according to the size of the second component in the multi-component attribute information 1 to obtain the attribute encoding order corresponding to the second component in the multi-component attribute information 1 of the current point cloud. The encoding device sorts the duplicate points in the first sorting according to the size of the third component in the multi-component attribute information 1 to obtain the attribute encoding order corresponding to the third component in the multi-component attribute information 1 of the current point cloud.

After sorting the current point cloud based on the above operations, the encoding device encodes the attribute information of the points in the current point cloud.

In an embodiment of the disclosure, the current point is a point in the current point cloud whose attribute information is to be encoded. In some examples, the current point is also referred to as a current point to be encoded, a point whose current attribute is to be encoded, or the like. An encoded point may be understood as a point whose geometric information and attribute information have both been encoded.

During the encoding process of the current point cloud, the encoding device performs the same encoding process for each point in the current point cloud, taking the current point to be encoded in the point cloud as an example. When performing attribute encoding on the current point, the encoding device first determines whether the current point is a duplicate point. The determining process may refer to the description of the above embodiments and will not be repeated here.

If the current point is not a duplicate point, the encoding device obtains encoded points in the current point cloud and selects at least one neighbor point of the current point from these encoded points. The encoding device obtains the predicted value of the attribute information of the current point according to the attribute information of at least one neighbor point of the current point.

If the current point is a duplicate point, the encoding device determines an attribute prediction method for the current point, where the attribute prediction method for the current point includes a duplicate point attribute prediction method proposed in the disclosure and another prediction method.

In one example, the encoding device determines the default prediction method of the encoding and decoding devices as the attribute prediction method for the current point.

In some examples, the encoding device selects one attribute prediction method (e.g., randomly selects one, or selects one based on encoding costs) from a plurality of preset attribute prediction methods as the attribute prediction method for the current point. In this case, the encoding device also needs to indicate the selected attribute prediction method for the current point to the decoding device, for example, by writing a flag bit for indicating the attribute prediction method for the current point into the code stream.

In one example, the encoding device determines the attribute prediction method for the current point based on a data type of the current point cloud.

When the encoding device determines that the attribute prediction method for the current point is the duplicate point attribute prediction method proposed in the embodiments of the disclosure, the method of the embodiments of the disclosure may be configured for attribute prediction.

If it is determined that the current point is a duplicate point and the duplicate point attribute prediction method proposed in the embodiments of the disclosure is configured for prediction, the encoding device determines the attribute prediction mode for the current point from the attribute prediction mode based on the pre-order point and the attribute prediction mode based on the K neighbor points.

The pre-order point of the current point is an attribute encoded point whose attribute is located before the current point in the attribute encoding order of the current point cloud.

In the embodiment of the disclosure, if the current point is a duplicate point, the attribute prediction mode of the current point includes at least one of an attribute prediction mode based on a pre-order point and an attribute prediction mode based on K neighbor points.

The attribute prediction mode based on the pre-order point refers to a mode of determining an attribute predicted value of the current point based on an attribute reconstructed value of the pre-order point of the current point. For example, a mode for determining the attribute predicted value of the current point by using the attribute reconstructed value of the pre-order point.

The attribute prediction mode based on K neighbor points refers to a mode of determining an attribute predicted value of the current point based on attribute reconstructed values of K neighbor points of the current point. For example, a mode for determining the attribute predicted value of the current point by using a weighted average value of attribute reconstructed values of K neighbor points of the current point.

Embodiments of the disclosure do not limit the specific manner in which the encoding device determines the attribute prediction mode of the current point.

In a possible implementation, the encoding device and the decoding device default to one of the attribute prediction mode based on the pre-order point and the attribute prediction mode based on the K neighbor points as the attribute prediction mode of the current point. For example, the encoding device and the decoding device default to the attribute prediction mode based on the pre-order point as the attribute prediction mode of the current point (or the current point cloud).

In a possible implementation, the encoding device randomly selects one attribute prediction mode from the attribute prediction mode based on the pre-order point and the attribute prediction mode based on the K neighbor points as the attribute prediction mode of the current point. Alternatively, the encoding device selects an attribute prediction mode with lowest costs from the attribute prediction mode based on the pre-order point and the attribute prediction mode based on the K neighbor points as the attribute prediction mode of the current point. Then, the encoding device writes indication information of the selected attribute prediction mode of the current point into the code stream. For example, if the attribute prediction mode of the current point is the attribute prediction mode based on the pre-order point, the flag bit in the indication information is set to 0. If the attribute prediction mode of the current point is the attribute prediction mode based on the K neighbor points, the flag bit in the indication information is set to 1. The decoding device may obtain the attribute prediction mode of the current point based on the value of the flag bit in the indication information.

In a possible implementation, the encoding device may further determine the attribute prediction mode of the current point based on the type of the current point cloud. For example, the encoding device and the decoding device agree to use the attribute prediction mode based on the pre-order point for attribute prediction for some types of point clouds, and to use the attribute prediction mode based on the K neighbor points for attribute prediction for some other types of point clouds. In this way, the encoding device may obtain the attribute prediction mode of the current point based on the type of the current point cloud.

In the embodiment of the disclosure, if the current point is a duplicate point, the encoding device determines the attribute prediction mode of the current point based on the foregoing operations. Then, operation S202 is performed.

S202: The encoding device predicts attribute information of the current point based on the attribute prediction mode of the current point, to obtain an attribute predicted value of the current point.

In the embodiment of the disclosure, if the current point is determined to be a duplicate point, the encoding device determines the attribute prediction mode of the current point from an attribute prediction mode based on a pre-order point and an attribute prediction mode based on K neighbor points. Then, the attribute information of the current point is predicted based on the attribute prediction mode of the current point, to obtain the attribute predicted value of the current point.

The prediction of the attribute information of the current point by the encoding device based on the attribute prediction mode of the current point is described below.

In the embodiment of the disclosure, the prediction of the attribute information of the current point by the encoding device based on the attribute prediction mode of the current point mainly includes the following cases:

Case 1: If the attribute prediction mode of the current point is the attribute prediction mode based on the pre-order point, the foregoing S202 includes the following operations S202-A1 and S202-A3:

S202-A1: The encoding device determines the type of the attribute information of the current point cloud, where the type of attribute information includes at least one of single-component attribute information, multi-component attribute information, and multiple types of attribute information, and the multiple types of attribute information include at least one of the following: N1 types of single-component attribute information, N2 types of multi-component attribute information, N3 types of single-component attribute information, and N4 types of multi-component attribute information, where N1 and N2 are both positive integers greater than 1, and N3 and N4 are positive integers.

S202-A2: The encoding device determines the attribute prediction sub-mode of the current point based on the type of the attribute information of the current point cloud, where the attribute prediction sub-mode includes at least one of a single-component attribute prediction mode and a multi-component attribute prediction mode.

S202-A3: The encoding device performs attribute prediction on the current point based on the attribute prediction sub-mode of the current point, to obtain the attribute predicted value of the current point.

A specific process for the encoding device to determine the attribute prediction sub-mode of the current point based on the type of the attribute information of the current point cloud in S202-A2 described above is introduced below.

In the embodiment of the disclosure, the encoding device determines the attribute prediction sub-mode of the current point from at least one of the single-component attribute prediction mode and the multi-component attribute prediction mode, based on the type of the attribute information of the current point cloud.

The specific manners of the single-component attribute prediction mode and the multi-component attribute prediction mode are not limited in embodiments of the disclosure.

In one example, the single-component attribute prediction mode includes at least one of the following modes:

Mode 1: a mode in which the attribute reconstructed value of the first attribute information of the pre-order point is determined as the predicted attribute value of the first attribute information of the current point, and a default sign is determined as a residual sign of the first attribute information of the current point, or a residual sign of the first attribute information is encoded, where the first attribute information is any single-component attribute information.

Mode 2: a mode in which a default value is determined as the predicted attribute value of the first attribute information of the current point, and a default sign is determined as a residual sign of the first attribute information of the current point, or the residual sign of the first attribute information is encoded.

In some examples, the multi-component attribute prediction mode may refer to a mode in which attribute reconstructed values of one or more components of M components of the second attribute information of the pre-order point are determined as attribute predicted values of one or more components of the second attribute information of the current point, where the second attribute information is any type of multi-component attribute information including M components, and M is a positive integer greater than 1.

In one example, the multi-component attribute prediction mode includes at least one of the following modes:

Mode 1: a mode of determining attribute reconstructed values of the M components of the second attribute information of the pre-order point as attribute predicted values of the M components of the second attribute information of the current point, and determining a default sign as residual signs of the M components of the second attribute information of the current point, or determining a default sign as residual signs of M1 components in the second attribute information of the current point, and encoding residual signs of M2 components other than the M1 components in the M components of the second attribute information of the current point, or encoding the residual signs of the M components of the second attribute information of the current point, M1 and M2 being both positive integers, and a sum of M1 and M2 being equal to M.

Mode 2: a mode of determining attribute reconstructed values of P components in the M components of the second attribute information of the pre-order point as attribute predicted values of P components of the second attribute information of the current point, determining a default value as attribute predicted values of M-P components of the second attribute information of the current point, and determining a default sign as residual signs of the M components of the second attribute information of the current point, or determining a default sign as residual signs of the P components of the second attribute information of the current point, and encoding residual signs of the M-P components of the second attribute information of the current point, or encoding the residual signs of the M components of the second attribute information of the current point, P being a positive integer less than M.

Mode 3: a mode of determining attribute reconstructed values of R components in the M components of the second attribute information of the pre-order point as attribute predicted values of R components of the second attribute information of the current point, determining, in the attribute prediction mode based on the K neighbor points, attribute predicted values of M-R components of the second attribute information of the current point, determining a default sign as residual signs of the M components of the second attribute information of the current point, or determining a default sign as residual signs of the R components of the second attribute information of the current point, and encoding residual signs of the M-R components of the second attribute information of the current point, or encoding the residual signs of the M components of the second attribute information of the current point, R being a positive integer less than M.

The embodiments of the disclosure do not limit the specific manner in which the encoding device determines the attribute prediction sub-mode of the current point based on the type of the attribute information of the current point cloud.

In a possible implementation, if the type of the attribute information of the current point cloud is single-component attribute information, the single-component attribute prediction mode is determined as the attribute prediction sub-mode of the current point.

In a possible implementation, if the type of the attribute information of the current point cloud is multi-component attribute information, the encoding device determines the multi-component attribute prediction mode as the attribute prediction sub-mode of the current point.

The above examples only show several possible attribute prediction sub-modes of the current point when the type of the attribute information of the current point cloud is multi-component attribute information. The attribute prediction sub-mode derived based on the above several possible attribute prediction sub-modes may also be used as a possible attribute prediction sub-mode of the current point.

In a possible implementation, if the type of the attribute information of the current point cloud is multiple types of attribute information, the encoding device determines the attribute prediction sub-mode of the current point from the single-component attribute prediction mode and the multi-component attribute prediction mode based on the multiple types of attribute information included in the current point cloud. For example, the encoding device uses the single-component attribute prediction mode to predict the single-component attribute information of the current point, and uses the multi-component attribute prediction mode to predict the multi-component attribute information of the current point.

In some embodiments, the encoding device determines the attribute prediction sub-mode of the current point from the single-component attribute prediction mode and the multi-component attribute prediction mode based on the multiple types of attribute information included in the current point cloud, at least including the following examples:

Example 1: If the current point cloud includes N1 types of single-component attribute information, the encoding device determines the single-component attribute prediction mode as an attribute prediction sub-mode of at least one of the N1 types of single-component attribute information of the current point.

Example 2: If the current point cloud includes N2 types of multi-component attribute information, the encoding device determines the multi-component attribute prediction mode as the attribute prediction sub-mode for at least one type of multi-component attribute information in the N2 types of multi-component attribute information of the current point.

Example 3: If the current point cloud includes N3 types of single-component attribute information and N4 types of multi-component attribute information, the encoding device determines the single-component attribute prediction mode as the attribute prediction sub-mode for at least one type of single-component attribute information in the N3 types of single-component attribute information, and/or determines the multi-component attribute prediction mode as the attribute prediction sub-mode for at least one type of multi-component attribute information in the N4 types of multi-component attribute information.

After determining the attribute prediction sub-mode of the current point based on the above operations, the encoding device performs the operation S202-A3 described above, and performs attribute prediction on the current point based on the attribute prediction sub-mode of the current point to obtain the attribute predicted value of the current point.

The foregoing describes a process of predicting the attribute information of the current point when the attribute prediction mode of the current point is the attribute prediction mode based on the pre-order point. The following describes a process of predicting the attribute information of the current point when the attribute prediction mode of the current point is the attribute prediction mode based on the K neighbor points, with reference to case 2.

Case 2: If the attribute prediction mode of the current point is the attribute prediction mode based on the K neighbor points, S202 includes the following operations S202-B1 and S202-B2:

S202-B1: The encoding device selects K neighbor points from the candidate point set of the current point.

S202-B2: The encoding device determines the attribute predicted value of the current point based on an attribute reconstructed value of at least one of the K neighbor points.

The embodiments of the disclosure do not limit a specific manner for the encoding device to determine the attribute predicted value of the current point based on the attribute reconstructed value of at least one of the K neighbor points.

In some embodiments, the encoding device directly determines an average value of the attribute reconstructed values of the K1 neighbor points as the attribute predicted value of the current point.

In some embodiments, the encoding device selects, from the K neighbor points, K1 neighbor points whose distances from the current point are less than or equal to a preset value, and determines the attribute predicted value of the current point based on attribute reconstructed values of the K1 neighbor points, K1 being a positive integer less than or equal to K.

In one example, the encoding device may determine an attribute reconstructed value of any one neighbor point in the K1 neighbor points as the attribute predicted value of the current point.

In one example, the encoding device may determine an average value of the attribute reconstructed values of the K1 neighbor points as the attribute predicted value of the current point.

In one example, the encoding device determines weights of the K1 neighbor points, and then determines the attribute predicted value of the current point based on the weights of the K1 neighbor points and the attribute reconstructed values of the K1 neighbor points.

Embodiments of the disclosure do not limit the specific manner of determining the weights of the K1 neighbor points.

Since the K1 neighbor points are duplicate points of the current point, and distances from the current point are 0, the weights of the K1 neighbor points cannot be determined based on reciprocals of the distances.

In one possible implementation, the embodiment of the disclosure may set the weights of the K1 neighbor points to a preset value (for example, the preset value=1).

In one possible implementation, the embodiment of the disclosure may alternatively set not completely identical weights for the K1 neighbor points. For example, completely different weights are set for the K1 neighbor points, or different weights are set for some of the K1 neighbor points and the same weight is set for some of the K1 neighbor points.

In one possible implementation, the encoding device may determine the weights of the K1 neighbor points based on magnitudes of the attribute reconstructed values of the K1 neighbor points. For example, the larger the attribute reconstructed value of the neighbor point, the larger the corresponding weight; the smaller the attribute reconstructed value of the neighbor point, the smaller the corresponding weight.

In one example, the encoding device determines weights of the K1 neighbor points and weights of K-K1 neighbor points in the K neighbor points, and determines a weighted average value of the attribute reconstructed values of the K neighbor points as the attribute predicted value of the current point based on the weight of each of the K neighbor points.

The foregoing embodiments describe the process of determining the attribute predicted value of the current point when the attribute prediction mode of the current point is the attribute prediction mode based on the pre-order point, and describe the process of determining the attribute predicted value of the current point when the attribute prediction mode of the current point is the attribute prediction mode based on the K neighbor points. Then, operation S203 is performed as follows.

S203: The encoding device encodes the attribute information of the current point based on the attribute predicted value of the current point.

In the embodiment of the disclosure, if the current point is a duplicate point, the encoding device determines the attribute predicted value of the current point based on the foregoing operations. Then, based on the attribute information and the attribute predicted value of the current point, the attribute residual value of the current point is determined, and a code stream is obtained by encoding the attribute residual value of the current point.

When the encoding device encodes the attribute residual value of the current point, the absolute value and the residual sign of the attribute residual value of the current point are encoded.

In some embodiments, the encoding device may determine whether to encode the residual sign of the attribute residual value of the current point based on the attribute prediction sub-mode of the current point.

For example, if the attribute prediction sub-mode of the current point includes the single-component attribute prediction mode, the encoding device determines a default sign as the residual sign of the single-component attribute information (for example, the first attribute information) of the current point, and then skips encoding of the residual sign of the single-component attribute information of the current point; or the encoding device encodes the residual sign of the single-component attribute information of the current point.

For another example, if the attribute prediction sub-mode of the current point includes mode 1 in the multi-component attribute prediction mode, the encoding device determines a default sign as residual signs of the M1 components in the multi-component attribute information (for example, the second attribute information) of the current point, and encodes residual signs of the M2 components in the M components of the second attribute information of the current point other than the M1 components. Alternatively, the encoding device determines a default sign as the residual signs of the M components of the second attribute information of the current point. Alternatively, the encoding device encodes the residual signs of the M components of the second attribute information of the current point.

For another example, if the attribute prediction sub-mode of the current point includes mode 2 in the multi-component attribute prediction mode, the encoding device determines a default sign as residual signs of the P components of the second attribute information of the current point, and encodes residual signs of the M-P components of the second attribute information of the current point. Alternatively, the encoding device determines a default sign as the residual signs of the M components of the second attribute information of the current point. Alternatively, the encoding device encodes the residual signs of the M components of the second attribute information of the current point.

For another example, if the attribute prediction sub-mode of the current point includes mode 3 in the multi-component attribute prediction mode, the encoding device determines a default sign as residual signs of the R components of the second attribute information of the current point, and encodes residual signs of the M-R components of the second attribute information of the current point. Alternatively, the encoding device determines a default sign as the residual signs of the M components of the second attribute information of the current point. Alternatively, the encoding device encodes the residual signs of the M components of the second attribute information of the current point.

The point cloud attribute encoding method in the encoding device is the inverse process of the point cloud attribute decoding method in the decoding device described above. The operations in the point cloud attribute encoding method in the encoding device may refer to the corresponding operations in the point cloud attribute decoding method in the decoding device, and are not described again herein to avoid repetition.

The point cloud attribute encoding method provided in the embodiment of the disclosure can achieve fast and effective prediction and encoding of attribute information of a duplicate point in a point cloud. Specifically, if the current point is a duplicate point in the current point cloud, the encoding device determines the attribute prediction mode of the current point, the attribute prediction mode including at least one of an attribute prediction mode based on a pre-order point and an attribute prediction mode based on K neighbor points, the pre-order point being an attribute encoded point located before the current point in an attribute encoding order of the current point cloud, the K neighbor points being K attribute encoded points nearest to the current point; predicts the attribute information of the current point based on the attribute prediction mode of the current point, to obtain the attribute predicted value of the current point; and performs attribute encoding on the current point based on the attribute predicted value of the current point. In this way, prediction and encoding of attribute information of a duplicate point can be implemented, thereby improving attribute encoding performance of a point cloud.

The preferred implementations of the disclosure are described in detail above with reference to the accompanying drawings. However, the disclosure is not limited to the specific details in the foregoing implementations, multiple simple deformations may be made to the technical solution of the disclosure within a range of the technical concept of the disclosure, and these simple deformations fall within the protection scope of the disclosure. For example, each specific technical feature described in the foregoing specific implementation may be combined in any suitable manner in a case of no contradiction. To avoid unnecessary repetition, various possible combination manners are not described otherwise in the disclosure. For another example, any combination may also be performed between different implementations of the disclosure, provided that the combination is not contrary to the idea of the disclosure, the combination is to also be considered as the content disclosed in the disclosure.

Further, in various embodiments of the disclosure, an order of sequence numbers of the foregoing processes does not indicate an execution sequence, and execution sequences of the processes are to be determined according to functions and internal logics thereof and are not to impose any limitation on an implementation process of the embodiments of the disclosure.

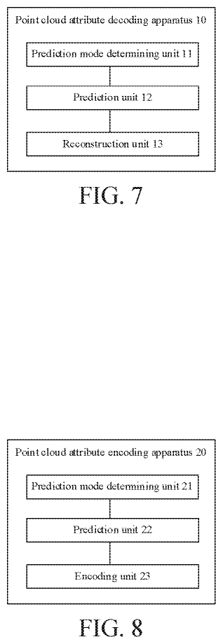

The method embodiments of the disclosure are described in detail above with reference to FIG. 5 to FIG. 6, and the apparatus embodiments of the disclosure are described in detail below with reference to FIG. 7 to FIG. 9.

FIG. 7 is a schematic block diagram of a point cloud attribute decoding apparatus according to an embodiment of the disclosure. The apparatus 10 is applied to a processor device, and the processor device may be a decoding device or a part of the decoding device.

As shown in FIG. 7, the point cloud attribute decoding apparatus 10 may include:
a prediction mode determining unit 11, configured to determine, if a current point whose attribute is to be decoded is a duplicate point in a current point cloud, an attribute prediction mode of the current point, the attribute prediction mode including at least one of an attribute prediction mode based on a pre-order point and an attribute prediction mode based on K neighbor points, the pre-order point being an attribute decoded point located before the current point in an attribute decoding order of the current point cloud, the K neighbor points being K attribute decoded points nearest to the current point, and K being a positive integer;
a prediction unit 12, configured to predict attribute information of the current point based on the attribute prediction mode of the current point, to obtain an attribute predicted value of the current point; and
a reconstruction unit 13, configured to determine an attribute reconstructed value of the current point based on the attribute predicted value of the current point.

In some embodiments, if the attribute prediction mode of the current point is the attribute prediction mode based on the pre-order point, the prediction unit 12 is specifically configured to determine an attribute prediction sub-mode of the current point, the attribute prediction sub-mode including at least one of a single-component attribute prediction mode and a multi-component attribute prediction mode; and perform attribute prediction for the current point based on the attribute prediction sub-mode of the current point, to obtain the attribute predicted value of the current point.

In some embodiments, the prediction unit 12 is specifically configured to determine a type of attribute information of the current point cloud, the type of the attribute information including at least one of single-component attribute information, multi-component attribute information, and multiple types of attribute information, the single-component attribute information being attribute information including one component, the multi-component attribute information being attribute information including multiple components, the multiple types of attribute information including at least one of the following: N1 types of single-component attribute information, N2 types of multi-component attribute information, N3 types of single-component attribute information, and N4 types of multi-component attribute information, N1 and N2 being both positive integers greater than 1, and N3 and N4 being positive integers; and determine the attribute prediction sub-mode of the current point based on the type of the attribute information of the current point cloud.

In some embodiments, the prediction unit 12 is specifically configured to: determine the single-component attribute prediction mode as the attribute prediction sub-mode of the current point if the type of the attribute information of the current point cloud is the single-component attribute information; determine the multi-component attribute prediction mode as the attribute prediction sub-mode of the current point if the type of the attribute information of the current point cloud is the multi-component attribute information; and determine, if the type of the attribute information of the current point cloud is the plurality of types of attribute information, the attribute prediction sub-mode of the current point from the single-component attribute prediction mode and the multi-component attribute prediction mode based on a plurality of types of attribute information included in the current point cloud.

In some embodiments, the prediction unit 12 is specifically configured to: determine, if the current point cloud includes N1 types of single-component attribute information, the single-component attribute prediction mode as an attribute prediction sub-mode of at least one of the N1 types of single-component attribute information of the current point; determine, if the current point cloud includes N2 types of multi-component attribute information, the multi-component attribute prediction mode as an attribute prediction sub-mode of at least one of the N2 types of multi-component attribute information of the current point; and determine, if the current point cloud includes N3 types of single-component attribute information and N4 types of multi-component attribute information, the single-component attribute prediction mode as an attribute prediction sub-mode of at least one of the N3 types of single-component attribute information, and/or determine the multi-component attribute prediction mode as an attribute prediction sub-mode of at least one of the N4 types of multi-component attribute information.

In some embodiments, the reconstruction unit 13 is specifically configured to: encode a code stream, and determine an absolute value of an attribute residual value of the current point; determine a residual sign of the attribute residual value of the current point based on the attribute prediction sub-mode of the current point; obtain the attribute residual value of the current point based on the absolute value and the residual sign of the attribute residual value; and obtain the attribute reconstructed value of the current point based on the attribute residual value and the attribute predicted value of the current point.

In some embodiments, the single-component attribute prediction mode includes at least one of the following: determining an attribute reconstructed value of first attribute information of the pre-order point as an attribute predicted value of the first attribute information of the current point, and determining a default sign as a residual sign of the first attribute information of the current point or decoding the residual sign of the first attribute information, the first attribute information being single-component attribute information; or determine a default value as an attribute predicted value of first attribute information of the current point, and determine a default sign as a residual sign of the first attribute information of the current point, or decode the residual sign of the first attribute information.

In some embodiments, the multi-component attribute prediction mode is to determine attribute reconstructed values of one or more of M components of second attribute information of the pre-order point as attribute predicted values of one or more components of second attribute information of the current point, the second attribute information being multi-component attribute information including M components, and M being a positive integer greater than 1.

In some embodiments, the multi-component attribute prediction mode includes at least one of the following: determining attribute reconstructed values of the M components of the second attribute information of the pre-order point as attribute predicted values of the M components of the second attribute information of the current point, and determining a default sign as residual signs of the M components of the second attribute information of the current point, or determining a default sign as residual signs of M1 components in the second attribute information of the current point, and decoding residual signs of M2 components other than the M1 components in the M components of the second attribute information of the current point, or decoding the residual signs of the M components of the second attribute information of the current point, M1 and M2 being both positive integers, and a sum of M1 and M2 being equal to M; or determining attribute reconstructed values of P components in the M components of the second attribute information of the pre-order point as attribute predicted values of P components of the second attribute information of the current point, determining a default value as attribute predicted values of M-P components of the second attribute information of the current point, and determining a default sign as residual signs of the M components of the second attribute information of the current point, or determining a default sign as residual signs of the P components of the second attribute information of the current point, and decoding residual signs of the M-P components of the second attribute information of the current point, or decoding the residual signs of the M components of the second attribute information of the current point, P being a positive integer less than M; or determining attribute reconstructed values of R components in the M components of the second attribute information of the pre-order point as attribute predicted values of R components of the second attribute information of the current point, determining, in the attribute prediction mode based on the K neighbor points, attribute predicted values of M-R components of the second attribute information of the current point, determining a default sign as residual signs of the M components of the second attribute information of the current point, or determining a default sign as residual signs of the R components of the second attribute information of the current point, and decoding residual signs of the M-R components of the second attribute information of the current point, or decoding the residual signs of the M components of the second attribute information of the current point, R being a positive integer less than M.

In some embodiments, the prediction mode determining unit 11 is further configured to: determine a distance between the current point and a decoded point in the current point cloud, and determine, based on the distance, whether the current point is a duplicate point; or determine whether the current point is a duplicate point based on geometric coordinates of the current point and geometric coordinates of a decoded point in the current point cloud; or determine whether the current point is a duplicate point based on a sequencing code of the current point and a sequencing code of a decoded point in the current point cloud, the sequencing code being a codeword obtained after geometric coordinates of a point in the point cloud are transformed in point cloud sequencing.

In some embodiments, if the current point cloud includes a plurality of types of attribute information, the prediction mode determining unit 11 is specifically configured to: determine a geometric distance between the current point and the candidate point based on geometric information of the current point and geometric information of the candidate point; determine an attribute distance between the current point and the candidate point based on the attribute information of the current point and attribute information of the candidate point; determine a comprehensive distance between the current point and the candidate point based on the geometric distance and the attribute information; and determine the distance between the current point and the candidate point based on the comprehensive distance.

In some embodiments, if the attribute prediction mode of the current point is the attribute prediction mode based on the K neighbor points, the prediction unit 12 is specifically configured to: select K neighbor points from the candidate point set of the current point; and determine the attribute predicted value of the current point based on an attribute reconstructed value of at least one of the K neighbor points.

In some embodiments, the prediction unit 12 is specifically configured to: determine an average value of attribute reconstructed values of the K neighbor points as the attribute predicted value of the current point; or select, from the K neighbor points, K1 neighbor points whose distances from the current point are less than or equal to a preset value, and determine the attribute predicted value of the current point based on attribute reconstructed values of the K1 neighbor points, K1 being a positive integer less than or equal to K.

In some embodiments, the prediction unit 12 is specifically configured to: determine an average value of the attribute reconstructed values of the K1 neighbor points as the attribute predicted value of the current point; or determine weights of the K1 neighbor points in the K neighbor points, and determine a weighted average value of the attribute reconstructed values of the K1 neighbor points as the attribute predicted value of the current point; or determine weights of the K1 neighbor points and weights of K-K1 neighbor points in the K neighbor points, and determine a weighted average value of the attribute reconstructed values of the K neighbor points as the attribute predicted value of the current point based on the weight of each of the K neighbor points.

The apparatus embodiment and the method embodiment may be corresponding to each other. For similar description, references may be made to the method embodiment. To avoid repetition, details are not described herein again. Specifically, the apparatus shown in FIG. 7 may perform the embodiment of the method shown in FIG. 5, and the foregoing and other operations and/or functions of the modules in the apparatus are respectively for implementing the corresponding method embodiment of the decoding device. To avoid repetition, details are not described herein again.

FIG. 8 is a schematic block diagram of a point cloud attribute encoding apparatus according to an embodiment of the disclosure. The apparatus 20 is applied to a processor device, and the processor device may be an encoding device or a part of the encoding device.

As shown in FIG. 8, the point cloud attribute encoding apparatus 20 may include:
a prediction mode determining unit 21, configured to determine, if a current point whose attribute information is to be encoded in a current point cloud is a duplicate point in the current point cloud, an attribute prediction mode of the current point, the attribute prediction mode including at least one of an attribute prediction mode based on a pre-order point and an attribute prediction mode based on K neighbor points, the pre-order point being an attribute encoded point located before the current point in an attribute encoding order of the current point cloud, the K neighbor points being K attribute encoded points nearest to the current point, and K being a positive integer;
a prediction unit 22, configured to predict attribute information of the current point based on the attribute prediction mode of the current point, to obtain an attribute predicted value of the current point; and
an encoding unit 23, configured to encode the attribute information of the current point based on the attribute predicted value of the current point, to obtain a code stream.

In some embodiments, the prediction mode determining unit 21 is further configured to, before determining whether the current point is a duplicate point, sort points in the current point cloud based on geometric information of the points in the current point cloud to obtain first sorting; and for duplicate points in the first sorting, sort the duplicate points in the first sorting based on attribute information of the duplicate points to obtain an attribute encoding order of the current point cloud.

In some embodiments, the prediction mode determining unit 21 is specifically configured to: if the attribute information of the duplicate point includes single-component attribute information, sort the duplicate points in the first sorting according to a size of the single-component attribute information to obtain the attribute encoding order of the current point cloud; if the attribute information of the duplicate point includes multi-component attribute information, sort the duplicate points in the first sorting according to a size of attribute information under one component in the multi-component attribute information to obtain the attribute encoding order of the current point cloud, or sort the duplicate points in the first sorting respectively according to a size of attribute information under each component in the plurality of component attribute information to obtain the attribute encoding order of the current point cloud; or
if the attribute information of the duplicate point includes N1 types of single-component attribute information, sort the duplicate points in the first sorting according to a size of one single-component attribute information in the N1 types of single-component attribute information to obtain the attribute encoding order of the current point cloud; or sort the duplicate points in the first sorting respectively according to a size of attribute information under each single component in the N1 types of single-component attribute information to obtain an attribute encoding order corresponding to the N1 types of single-component attribute information of the current point cloud, where N1 is a positive integer greater than 1; or
if the attribute information of the duplicate point includes N2 types of multi-component attribute information, sort the duplicate points in the first sorting according to a size of attribute information under one component of an ith multi-component attribute information in the N2 types of multi-component attribute information to obtain the attribute encoding order of the current point cloud; or sort the duplicate points in the first sorting respectively according to a size of attribute information under one component of each multi-component in the N2 types of multi-component attribute information to obtain an attribute encoding order corresponding to the N2 types of attribute information of the current point cloud, where N2 is a positive integer greater than 1, and i is a positive integer less than or equal to N2; or sort the duplicate points in the first sorting respectively according to a size of attribute information under each component of each multi-component in the N2 types of multi-component attribute information to obtain an attribute encoding order corresponding to each component in the N2 types of attribute information of the current point cloud, where N2 is a positive integer greater than 1, and i is a positive integer less than or equal to N2; or
if the attribute information of the duplicate point includes N3 types of single-component attribute information and N4 types of multi-component attribute information, sort the duplicate points in the first sorting respectively according to a size of one or each type of single-component attribute information in the N3 types of single-component attribute information, and/or according to a size of attribute information under one component or each component of one or each type of multi-component attribute information in the N4 types of multi-component attribute information, to obtain the attribute encoding order of the current point cloud, where N3 and N4 are positive integers.

The apparatus embodiment and the method embodiment may be corresponding to each other. For similar description, references may be made to the method embodiment. To avoid repetition, details are not described herein again. Specifically, the apparatus shown in FIG. 8 may perform the embodiment of the method shown in FIG. 6, and the foregoing and other operations and/or functions of the modules in the apparatus are respectively for implementing the corresponding method embodiment of the encoding device. To avoid repetition, details are not described herein again.

The foregoing describes the apparatus in the embodiment of the disclosure from a perspective of a functional module with reference to the accompanying drawings. The function module may be implemented in a hardware form, may be implemented in an instruction in a software form, or may be implemented in a combination of hardware and software modules. Specifically, the operations of the method embodiments in the disclosure may be completed by using an integrated logic circuit of hardware in a processor and/or an instruction in a form of software. The operations of the method disclosed with reference to the embodiments of the disclosure may be directly performed by a hardware decoding processor, or may be performed by using a combination of hardware and software modules in a decoding processor. In some embodiments, the software module may be located in a storage medium that is mature in the art, such as a random access memory, a flash memory, a read-only memory, a programmable read-only memory, an electrically erasable programmable memory, or a register. The storage medium is located in the memory. The processor reads information in the memory and completes the operations of the method embodiments in combination with hardware thereof.

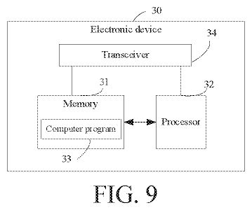

FIG. 9 is a schematic block diagram of an electronic device according to an embodiment of the disclosure. The electronic device in FIG. 9 may be the foregoing point cloud encoding device or point cloud decoding device.

As shown in FIG. 9, the electronic device 30 may include:
a memory 31 and a processor 32. The memory 31 is configured to store a computer program 33 and transmit the program code 33 to the processor 32. In other words, the processor 32 may invoke and run the computer program 33 from the memory 31 to implement the method in the embodiments of the disclosure.

For example, the processor 32 may be configured to perform the operations in the foregoing method 200 according to instructions in the computer program 33.

In some embodiments of the disclosure, the processor 32 may include but is not limited to:
a general purpose processor, a digital signal processor (DSP), an application-specific integrated circuit (ASIC), a field programmable gate array (FPGA) or another programmable logic device, a discrete gate or a transistor logic device, a discrete hardware component, or the like.

In some embodiments of the disclosure, the memory 31 includes but is not limited to:
a volatile memory and/or a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM) serving as an external cache. Through illustrative but not limited description, RAMs in many forms, for example, a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DRRAM), are available.

In some embodiments of the disclosure, the computer program 33 may be divided into one or more modules, and the one or more modules are stored in the memory 31 and executed by the processor 32, so as to complete the page recording method provided in the disclosure. The one or more modules may be a series of computer program instruction segments that can perform specific functions, and the instruction segment is configured for describing an execution process of the computer program 33 in the electronic device 30.

As shown in FIG. 9, the electronic device 30 may further include:
a transceiver 34, where the transceiver 34 may be connected to the processor 32 or the memory 31.

The processor 32 may control the transceiver 34 to communicate with another device. Specifically, the processor 32 may transmit information or data to the another device, or receive information or data transmitted by the another device. The transceiver 34 may include a transmitter and a receiver. The transceiver 34 may further include an antenna, and a quantity of antennas may be one or more.

Components in the electronic device 30 are connected by using a bus system. In addition to a data bus, the bus system further includes a power bus, a control bus, and a status signal bus.

According to one aspect of the disclosure, a computer storage medium is provided, and a computer program is stored on the computer storage medium. When the computer program is executed by a computer, the computer is enabled to perform the method in the foregoing method embodiment. Alternatively, an embodiment of the disclosure further provides a computer program product including instructions. When the instructions are executed by a computer, the computer is enabled to perform the method in the foregoing method embodiment.

Another aspect of the disclosure provides a computer program product or a computer program, the computer program product or the computer program including computer instructions, the computer instructions being stored in a computer readable storage medium. A processor of a computer device reads the computer instructions from the computer readable storage medium, and the processor executes the computer instructions, so that the computer device performs the method in the foregoing method embodiment.

The foregoing content is merely specific implementations of the disclosure, but are not intended to limit the protection scope of the disclosure. Any variation or replacement readily figured out by a person skilled in the art within the technical scope disclosed in the disclosure shall fall within the protection scope of the disclosure. Therefore, the protection scope of the disclosure shall be subject to the protection scope of the claims.

What is claimed is:

1. A point cloud attribute decoding method, performed by a processor device, the method comprising:
determining whether a current point in a current point cloud is a duplicate point, the current point having attribute information to be decoded;
based on determining that the current point is the duplicate point, determining, for the current point, an attribute prediction mode, the attribute prediction mode comprising at least one of an attribute prediction mode based on a pre-order point or an attribute prediction mode based on K neighbor points, the pre-order point being an attribute decoded point that precedes the current point in an attribute decoding order for the current point cloud, the K neighbor points being K attribute decoded points nearest to the current point among decoded points in the current point cloud, and K being a positive integer;
predicting attribute information based on the attribute prediction mode to obtain an attribute predicted value; and
determining an attribute reconstructed value based on the attribute predicted value.

2. The method according to claim 1, wherein the attribute prediction mode is the attribute prediction mode based on the pre-order point, and
wherein the predicting the attribute information based on the attribute prediction mode to obtain an attribute predicted value comprises:
determining, for the current point, an attribute prediction sub-mode, the attribute prediction sub-mode comprising at least one of a single-component attribute prediction mode or a multi-component attribute prediction mode; and
performing attribute prediction based on the attribute prediction sub-mode to obtain the attribute predicted value.

3. The method according to claim 2, wherein the determining, for the current point, the attribute prediction sub-mode comprises:
determining a type of attribute information corresponding to the current point cloud, the type of attribute information comprising at least one of single-component attribute information, multi-component attribute information, or multiple types of attribute information, the single-component attribute information comprising one component, the multi-component attribute information comprising multiple components, the multiple types of attribute information comprising at least one of N1 types of single-component attribute information, N2 types of multi-component attribute information, or N3 types of single-component attribute information and N4 types of multi-component attribute information, N1 and N2 being integers greater than 1, and N3 and N4 being positive integers; and
determining the attribute prediction sub-mode based on the type of attribute information corresponding to the current point cloud.

4. The method according to claim 3, wherein the determining the attribute prediction sub-mode based on the type of attribute information corresponding to the current point cloud comprises:
determining the single-component attribute prediction mode as the attribute prediction sub-mode based on the type of the attribute information corresponding to the current point cloud being the single-component attribute information;
determining the multi-component attribute prediction mode as the attribute prediction sub-mode based on the type of attribute information corresponding to the current point cloud being the multi-component attribute information; and
determining the attribute prediction sub-mode from the single-component attribute prediction mode and the multi-component attribute prediction mode based on the type of attribute information for the current point cloud being multiple types of attribute information and based on the multiple types of attribute information included in the current point cloud.

5. The method according to claim 4, wherein the determining the attribute prediction sub-mode from the single-component attribute prediction mode and the multi-component attribute prediction mode comprises:
determining the single-component attribute prediction mode as the attribute prediction sub-mode corresponding to at least one type of single-component attribute information among the N1 types of single-component attribute information based on the current point cloud including the N1 types of single-component attribute information;
determining the multi-component attribute prediction mode as the attribute prediction sub-mode corresponding to at least one type of multi-component attribute information among the N2 types of multi-component attribute information based on the current point cloud including the N2 types of multi-component attribute information; and
determining at least one of (i) the single-component attribute prediction mode as the attribute prediction sub-mode corresponding to at least one type of single-component attribute information among the N3 types of single-component attribute information or (ii) the multi-component attribute prediction mode as the attribute prediction sub-mode corresponding to at least one type of multi-component attribute information among the N4 types of multi-component attribute information based on the current point cloud including the N3 types of single-component attribute information and the N4 types of multi-component attribute information.

6. The method according to claim 2, wherein the determining the attribute reconstructed value based on the attribute predicted value comprises:
decoding a code stream to determine an absolute value of an attribute residual value;
determining a residual sign of the attribute residual value based on the attribute prediction sub-mode;
obtaining the attribute residual value based on the absolute value and the residual sign of the attribute residual value; and
obtaining the attribute reconstructed value based on the attribute residual value and the attribute predicted value.

7. The method according to claim 2, wherein the single-component attribute prediction mode comprises at least one of:
determining an attribute reconstructed value for first attribute information of the pre-order point as an attribute predicted value corresponding to first attribute information, and determining a default sign as a residual sign corresponding to the first attribute information or decoding the residual sign corresponding to the first attribute information, the first attribute information being single-component attribute information; or
determining a default value as the attribute predicted value corresponding to the first attribute information, and determining a default sign as the residual sign corresponding to the first attribute information, or decoding the residual sign corresponding to the first attribute information.

8. The method according to claim 2, wherein the multi-component attribute prediction mode comprises determining attribute reconstructed values corresponding to one or more components among M components of second attribute information of the pre-order point as attribute predicted values corresponding to one or more corresponding components of the second attribute information, the second attribute information being multi-component attribute information comprising M components, and M being an integer greater than 1.

9. The method according to claim 8, wherein the multi-component attribute prediction mode comprises at least one of:
determining attribute reconstructed values corresponding to the M components of the second attribute information of the pre-order point as attribute predicted values corresponding to the M components of the second attribute information, and determining a default sign as a residual sign corresponding to each of the M components of the second attribute information, or determining a default sign as a residual sign corresponding to each of M1 components among the M components of the second attribute information, and decoding residual signs corresponding to M2 components other than the M1 components among the M components of the second attribute information, or decoding the residual signs corresponding to the M components of the second attribute information, M1 and M2 being both positive integers, and a sum of M1 and M2 being equal to M; or
determining attribute reconstructed values corresponding to P components among the M components of the second attribute information of the pre-order point as attribute predicted values corresponding to P components of the second attribute information, determining a default value as an attribute predicted value corresponding to each of M-P components of the second attribute information, and determining a default sign as a residual sign corresponding to each of the M components of the second attribute information, or determining the default sign as a residual sign corresponding to each of the P components of the second attribute information, and decoding residual signs corresponding to the M-P components of the second attribute information, or decoding the residual signs corresponding to the M components of the second attribute information, P being a positive integer less than M; or
determining attribute reconstructed values corresponding to R components among the M components of the second attribute information of the pre-order point as attribute predicted values corresponding to R components of the second attribute information, determining, based on the attribute prediction mode based on the K neighbor points, attribute predicted values corresponding to M-R components of the second attribute information, determining a default sign as a residual sign corresponding to each of the M components of the second attribute information, or determining a default sign as a residual sign corresponding to each of the R components of the second attribute information, and decoding residual signs corresponding to the M-R components of the second attribute information, or decoding the residual signs corresponding to the M components of the second attribute information, R being a positive integer less than M.

10. The method according to claim 1, wherein the determining whether the current point is the duplicate point comprises:
determining a distance between the current point and a decoded point in the current point cloud, and determining whether the current point is the duplicate point based on the distance; or
determining whether the current point is the duplicate point based on geometric coordinates of the current point and geometric coordinates of a decoded point in the current point cloud; or
determining whether the current point is the duplicate point based on a sequencing code of the current point and a sequencing code of the decoded point in the current point cloud, the sequencing code being a codeword obtained by transforming geometric coordinates of a point in the current point cloud during point cloud sequencing.

11. The method according to claim 10, wherein the current point cloud comprises multiple types of attribute information, and wherein the determining the distance between the current point and the decoded point in the current point comprises:
determining a geometric distance between the current point and the decoded point based on geometric information of the current point and geometric information of the decoded point;
determining an attribute distance between the current point and the decoded point based on the attribute information of the current point and attribute information of the decoded point;
determining a comprehensive distance between the current point and the decoded point based on the geometric distance and the attribute information; and
determining the distance between the current point and the decoded point based on the comprehensive distance.

12. The method according to claim 1, wherein the attribute prediction mode of the current point is the attribute prediction mode based on the K neighbor points, and wherein the predicting attribute information based on the attribute prediction mode of the current point to obtain an attribute predicted value comprises:
selecting K neighbor points from a candidate point set for the current point; and
determining the attribute predicted value based on an attribute reconstructed value corresponding to at least one of the K neighbor points.

13. The method according to claim 12, wherein the determining the attribute predicted value of the current point based the an attribute reconstructed value corresponding to the at least one of the K neighbor points comprises:
determining an average of attribute reconstructed values corresponding to the K neighbor points as the attribute predicted value; or
selecting, from the K neighbor points, K1 neighbor points having distances from the current point that are less than or equal to a preset value, and determining the attribute predicted value based on attribute reconstructed values corresponding to the K1 neighbor points, K1 being a positive integer less than or equal to K.

14. The method according to claim 13, wherein the determining the attribute predicted value based on attribute reconstructed values corresponding to the K1 neighbor points comprises:
determining an average of the attribute reconstructed values corresponding to the K1 neighbor points as the attribute predicted value; or
determining weights corresponding to the K1 neighbor points among the K neighbor points, and determining a weighted average of the attribute reconstructed values corresponding to the K1 neighbor points as the attribute predicted value; or
determining weights corresponding to the K1 neighbor points and weights corresponding to K-K1 neighbor points among the K neighbor points, and determining a weighted average of the attribute reconstructed values corresponding to the K neighbor points as the attribute predicted value based on the weights corresponding to the K neighbor points.

15. A point cloud attribute encoding method, performed by a processor device, the method comprising:
determining whether a current point in a current point cloud is a duplicate point, the current point having attribute information to be encoded;
based on determining that the current point is the duplicate point, determining, for the current point, an attribute prediction mode, the attribute prediction mode comprising at least one of an attribute prediction mode based on a pre-order point or an attribute prediction mode based on K neighbor points, the pre-order point being an attribute encoded point that precedes the current point in an attribute encoding order corresponding to the current point cloud, the K neighbor points being K attribute encoded points nearest to the current point among encoded points in the current point cloud, and K being a positive integer;
predicting attribute information based on the attribute prediction mode to obtain an attribute predicted value of the current point; and
encoding the attribute information of the current point based on the attribute predicted value to obtain a code stream.

16. A point cloud attribute decoding apparatus comprising:
at least one memory configured to store program code; and
at least one processor configured to read the program code and operate as instructed by the program code, the program code including:
duplicate determining code configured to cause the at least one processor to determine whether a current point in a current point cloud is a duplicate point, the current point having attribute information to be decoded;
prediction mode determining code configured to cause the at least one processor to, based on determining that the current point is the duplicate point, determine, for the current point, an attribute prediction mode, the attribute prediction mode comprising at least one of an attribute prediction mode based on a pre-order point or an attribute prediction mode based on K neighbor points, the pre-order point being an attribute decoded point that precedes the current point in an attribute decoding order for the current point cloud, the K neighbor points being K attribute decoded points nearest to the current point among decoded points in the current point cloud, and K being a positive integer;
prediction code configured to cause the at least one processor to predict attribute information based on the attribute prediction mode to obtain an attribute predicted value; and
reconstruction code configured to determine an attribute reconstructed value based on the attribute predicted value.

17. The point cloud attribute decoding apparatus according to claim 16, wherein the attribute prediction mode is the attribute prediction mode based on the pre-order point, and
wherein the prediction code is configured to cause the at least one processor to:
determine, for the current point, an attribute prediction sub-mode, the attribute prediction sub-mode comprising at least one of a single-component attribute prediction mode or a multi-component attribute prediction mode; and
perform attribute prediction based on the attribute prediction sub-mode to obtain the attribute predicted value.

18. The point cloud attribute decoding apparatus according to claim 17, wherein the prediction code is configured to cause the at least one processor to:
determine a type of attribute information corresponding to the current point cloud, the type of attribute information comprising at least one of single-component attribute information, multi-component attribute information, or multiple types of attribute information, the single-component attribute information comprising one component, the multi-component attribute information comprising multiple components, the multiple types of attribute information comprising at least one of N1 types of single-component attribute information, N2 types of multi-component attribute information, or N3 types of single-component attribute information and N4 types of multi-component attribute information, N1 and N2 being integers greater than 1, and N3 and N4 being positive integers; and
determine the attribute prediction sub-mode based on the type of attribute information corresponding to the current point cloud.

19. The point cloud attribute decoding apparatus according to claim 18, wherein the prediction code is configured to cause the at least one processor to:
determine the single-component attribute prediction mode as the attribute prediction sub-mode based on the type of the attribute information corresponding to the current point cloud being the single-component attribute information;
determine the multi-component attribute prediction mode as the attribute prediction sub-mode based on the type of attribute information corresponding to the current point cloud being the multi-component attribute information; and
determine the attribute prediction sub-mode from the single-component attribute prediction mode and the multi-component attribute prediction mode based on the type of attribute information for the current point cloud being multiple types of attribute information and based on the multiple types of attribute information included in the current point cloud.

20. The point cloud attribute decoding apparatus according to claim 18, wherein the prediction code is configured to cause the at least one processor to:
determine the single-component attribute prediction mode as the attribute prediction sub-mode corresponding to at least one type of single-component attribute information among the N1 types of single-component attribute information based on the current point cloud including the N1 types of single-component attribute information;
determine the multi-component attribute prediction mode as the attribute prediction sub-mode corresponding to at least one type of multi-component attribute information among the N2 types of multi-component attribute information based on the current point cloud including the N2 types of multi-component attribute information; and
determine at least one of (i) the single-component attribute prediction mode as the attribute prediction sub-mode corresponding to at least one type of single-component attribute information among the N3 types of single-component attribute information or (ii) the multi-component attribute prediction mode as the attribute prediction sub-mode corresponding to at least one type of multi-component attribute information among the N4 types of multi-component attribute information based on the current point cloud including the N3 types of single-component attribute information and the N4 types of multi-component attribute information.
